(19) United States
(12) Patent Application Publication
(10) Pub. No.: US 2026/0292815 A1
(43) Pub. Date: Sep. 24, 2026

(54) METHOD AND DEVICE FOR PERFORMING RESOURCE REQUEST IN WIRELESS COMMUNICATION SYSTEM

(71) Applicant: LG ELECTRONICS INC., Seoul (KR)

(72) Inventors: Eunjong LEE, Seoul (KR); Kyungho LEE, Seoul (KR); Bonghoe KIM, Seoul (KR); Sangrim LEE, Seoul (KR)

(73) Assignee: LG ELECTRONICS INC., Seoul (KR)

(21) Appl. No.: 18/881,148

(22) PCT Filed: Jul. 4, 2022
(86) PCT No.: PCT/KR2022/009612

§ 371 Date: Jan. 3, 2025

(51) Int. Cl. H04W 72/1268; H04W 8/24; H04W 28/02

(52) U.S. Cl. CPC H04W 72/1268; H04W 8/24; H04W 28/0278

(57) ABSTRACT

The present disclosure relates to a method for operating a terminal in a wireless communication system, and the method may comprise transmitting, by the terminal, terminal capability information to a base station, receiving scheduling request (SR) configuration information based on the terminal capability information from the base station, and triggering a first SR based on the SR configuration information and transmitting the first SR to the base station. The first SR may be an SR that is triggered and transmitted to the base station before first data occurs in a buffer of the terminal.

### CROSS-REFERENCE TO RELATED APPLICATION(S)

This application is the National Stage filing under 35 U.S.C. 371 of International Application No. PCT/KR2022/009612, filed on Jul. 4, 2022, the contents of which are all incorporated by reference herein in its entirety.

### TECHNICAL FIELD

The present disclosure relates to a wireless communication system, and more particularly, to a method and apparatus for performing resource request in a wireless communication system. Specifically, the present disclosure relates to a method and apparatus for performing resource request based on traffic prediction.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure relates to a method and apparatus for performing resource request in a wireless communication system.

The present disclosure relates to a method and apparatus for performing resource request by predicting a traffic occurrence time of a terminal in a wireless communication system.

The present disclosure relates to a method and apparatus for performing resource request by predicting a traffic occurrence time based on an artificial intelligence (AI)/machine learning (ML) model of a terminal in a wireless communication system.

The present disclosure relates to a method and apparatus for transmitting AI/ML model capability information of a terminal to a base station in a wireless communication system.

The present disclosure relates to a method and apparatus for setting a scheduling request (SR) configuration based on a traffic occurrence time of a terminal in a wireless communication system.

The present disclosure relates to a method and apparatus for triggering an SR based on a traffic occurrence time of a terminal in a wireless communication system.

The present disclosure relates to a method and apparatus for triggering a buffer status report (BSR) based on a traffic occurrence time of a terminal in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method for operating a terminal in a wireless communication system may comprise transmitting, by the terminal, terminal capability information to a base station, receiving, from the base station, scheduling request (SR) configuration information based on the terminal capability information, and triggering a first SR based on the SR configuration information and transmitting the first SR to the base station. The first SR may be an SR that is triggered and transmitted to the base station before first data occurs in a buffer of the terminal.

In addition, as an example of the present disclosure, a method for operating a base station in a wireless communication system may comprise receiving, from a terminal, terminal capability information, transmitting, to the terminal, scheduling request (SR) configuration information based on the terminal capability information, and receiving, from the terminal, a first SR triggered based on the SR configuration information. The first SR may be an SR that is triggered and transmitted to the base station before first data occurs in a buffer of the terminal.

In addition, as an example of the present disclosure, a terminal in a wireless communication system may comprise a transceiver and a processor coupled with the transceiver, and the processor may be configured to transmit terminal capability information to a base station by using the transceiver, to receive, from the base station, scheduling request (SR) configuration information based on the terminal capability information by using the transceiver, and to trigger a first SR based on the SR configuration information and transmit the first SR to the base station by using the transceiver. The first SR may be an SR that is triggered and transmitted to the base station before first data occurs in a buffer of the terminal.

In addition, as an example of the present disclosure, a base station in a wireless communication system may comprise a transceiver and a processor coupled with the transceiver, and the processor may be configured to receive, from a terminal, terminal capability information by using the transceiver, to transmit, to the terminal, scheduling request (SR) configuration information based on the terminal capability information by using the transceiver, and to receive, from the terminal, a first SR triggered based on the SR configuration information by using the transceiver. The first SR may be an SR that is triggered and transmitted to the base station before first data occurs in a buffer of the terminal.

In addition, as an example of the present disclosure, a device may comprise at least one memory and at least one processor functionally coupled with the at least one memory, and the at least one processor may control the device to transmit terminal capability information to a base station, to receive, from the base station, scheduling request (SR) configuration information based on the terminal capability information, and to trigger a first SR based on the SR configuration information and transmit the first SR to the base station by using the transceiver. The first SR may be an SR that is triggered and transmitted to the base station before first data occurs in a buffer of the terminal.

In addition, as an example of the present disclosure, a non-transitory computer-readable medium storing at least one instruction may comprise the at least one instruction that is executable by a processor, and the at least one instruction may be configured to transmit terminal capability information to a base station, to receive, from the base station, scheduling request (SR) configuration information based on the terminal capability information, and to trigger a first SR based on the SR configuration information and transmit the first SR to the base station by using the transceiver. The first SR may be an SR that is triggered and transmitted to the base station before first data occurs in a buffer of the terminal.

In addition, the following may be commonly applied.

As an example of the present disclosure, a terminal may be equipped with an artificial intelligence (AI)/machine learning (ML) model for uplink traffic prediction, and an occurrence time of first data in a buffer of the terminal may be predicted through the AI/ML model for uplink traffic prediction.

In addition, as an example of the present disclosure, terminal capability information may include at least one of information related to whether a terminal is equipped with an AI/ML model for uplink traffic prediction, information related to a method of performing learning based on the AI/ML model, type information of output data for the AI/ML model, time unit information for a traffic occurrence time for the output data, and predictable time information based on the AI/ML model.

In addition, as an example of the present disclosure, buffer size information based on first data may further be predicted through an AI/ML model for uplink traffic prediction of a terminal.

In addition, as an example of the present disclosure, when buffer size information based on first data is predicted, a terminal may trigger and transmit a first buffer status report (BSR) including at least one of identification information for the first data, occurrence time information of the first data, and buffer size information based on the first data to a base station.

In addition, as an example of the present disclosure, when an uplink resource for a triggered first BSR is not present in a terminal, an SR may be triggered and transmitted to a base station, and when the triggered SR is a first SR, the first BSR may include identification information for first data and buffer size information based on the first data, and occurrence time information of the first data may be indicated to a base station through the first SR.

In addition, as an example of the present disclosure, reliability information of a first SR may further be derived based on an AI/ML model for uplink traffic prediction of a terminal, and the reliability information of the first SR may be transmitted to a base station with the first SR.

In addition, as an example of the present disclosure, based on SR configuration information, at least one first SR physical uplink control channel (PUCCH) resource and at least one second SR PUCCH resource are set in a terminal, the at least one SR PUCCH resource may be a PUCCH resource for SR transmission that is triggered based on occurrence time prediction of first data before data occurs in a buffer of the terminal, and the at least one second SR PUCCH resource may be a PUCCH resource for SR transmission that is triggered based on data that occurs in the buffer of the terminal.

In addition, as an example of the present disclosure, a third SR PUCCH resource is further set in a terminal based on SR configuration information, and the third SR PUCCH resource may be a PUCCH resource that cancels a first SR based on prediction failure information indicating that first data does not occur at an occurrence time based on occurrence time prediction.

In addition, as an example of the present disclosure, a first SR may include identification information for first data and occurrence time prediction information of the first data.

In addition, as an example of the present disclosure, a first SR may further include prediction success rate information indicating that first data occurs at an occurrence time based on occurrence time prediction information of the first data.

In addition, as an example of the present disclosure, SR configuration information may include information on a plurality of SR setting sets based on prediction success rate information, a terminal may trigger a first SR based on a first SR setting set that is set among the plurality of SR setting sets, and the SR setting set, which is set in the terminal, may be dynamically changed based on the prediction success rate information.

In addition, as an example of the present disclosure, a terminal receives an uplink grant indicating an uplink resource based on a first SR from a base station, and when first data does not occur at a predicted occurrence time, the terminal may indicate cancellation of the first SR to the base station.

In addition, as an example of the present disclosure, a terminal may indicate cancellation of a first SR through at least one of a medium access control (MAC) control element (CE) indicating the cancellation of the first SR, a BSR set to 0, and a physical uplink shared channel (PUSCH) including null data.

In addition, as an example of the present disclosure, in case that a terminal detects occurrence of data in a buffer of the terminal based on SR configuration information, the terminal may trigger and transmit a second SR to a base station.

As is apparent from the above description, the embodiments of the present disclosure have the following effects.

It is possible to provide a method for performing resource request in embodiments based on the present disclosure.

It is possible to provide a method for predicting a traffic occurrence time of a terminal and performing resource request in embodiments based on the present disclosure.

It is possible to provide a method for performing resource request by predicting a traffic occurrence time based on an AI/ML model of a terminal in embodiments based on the present disclosure.

It is possible to provide a method for transmitting AL/ML model capability information of a terminal to a base station in embodiments based on the present disclosure.

It is possible to provide a method for setting an SR configuration based on a traffic occurrence time of a terminal in embodiments based on the present disclosure.

It is possible to provide a method for triggering an SR based on a traffic occurrence time of a terminal in embodiments based on the present disclosure.

It is possible to provide a method for triggering a BSR based on a traffic occurrence time of a terminal in embodiments based on the present disclosure.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of artificial intelligence (AI) device applicable to the present disclosure.

FIG. 5 is a view showing a method by which a terminal requests an uplink resource to a base station according to an embodiment of the present disclosure.

FIG. 6 is a view showing a method for operating a terminal according to an embodiment of the present disclosure.

FIG. 7 is a view showing a method for performing a capability negotiation procedure between a terminal and a base station according to an embodiment of the present disclosure.

FIG. 8 is a view showing a method for triggering a predictive SR according to an embodiment of the present disclosure.

FIG. 9 is a view showing a method by which a plurality of SR configuration sets are set in a terminal according to an embodiment of the present disclosure.

FIG. 10 is a flowchart showing a method by which a terminal performs resource request according to an embodiment of the present disclosure.

FIG. 11 is a flowchart showing a method by which a base station allocates an uplink resource based on a resource request according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

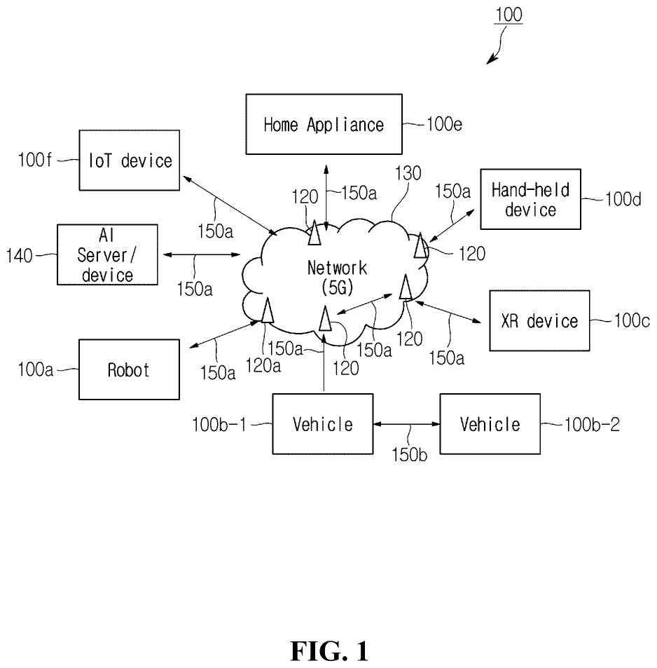

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Communication System Applicable to the Present Disclosure

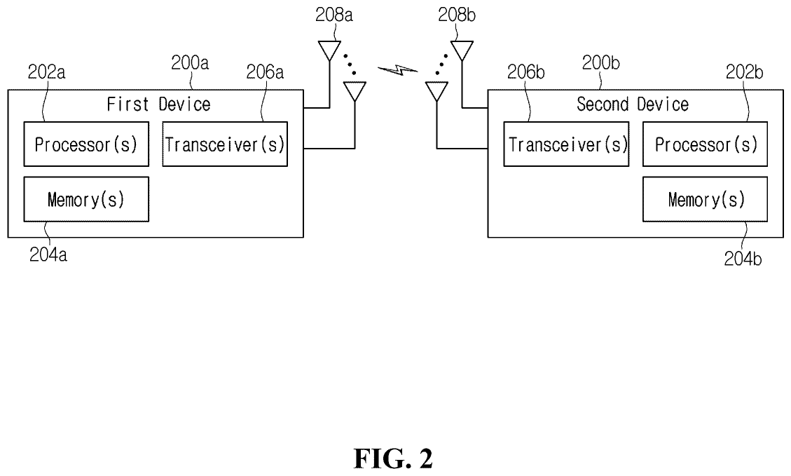

FIG. 2 is a view showing an example of a wireless apparatus applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

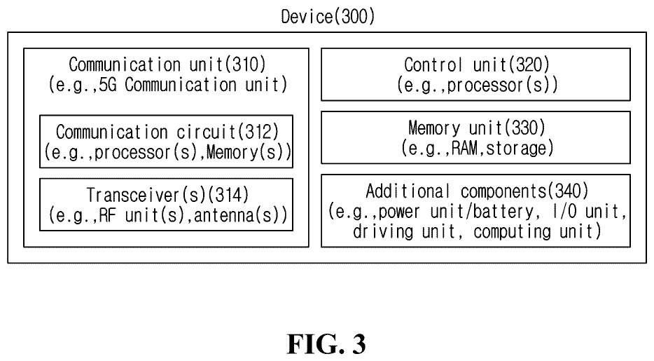

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

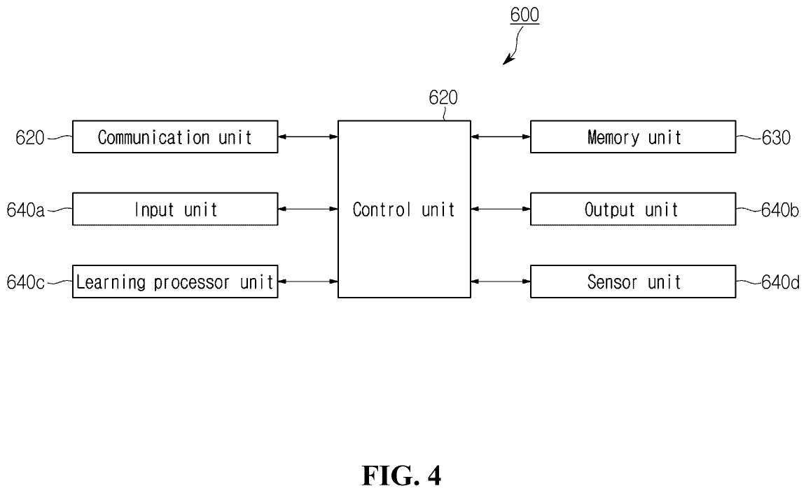

FIG. 4 is a view showing an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 4, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak | 1 | Tbps |
| data rate | | |
| E2E latency | 1 | ms |
| Maximum spectral | 100 | bps/Hz |
| efficiency | | |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

As an example, as described above, a new communication system (e.g., 6G system) may perform communication based on an AI. Herein, when a terminal performs uplink transmission to a base station, the terminal may be allocated an uplink resource from the base station and perform uplink transmission through the allocated resource. However, significant latency may occur in case the terminal perceives occurrence of data, performs resource request to the base station according to a resource request configuration for data transmission, and transmits data through a resource obtained based on the request.

In a new communication system (e.g., 6G system), a low-latency requirement may be higher in consideration of ultra reliable low latency communication (URLLC). Accordingly, the low-latency requirement may not be satisfied by an operation of being allocated an uplink resource based on an existing resource request procedure and performing uplink transmission based on it, and a method for performing resource request based on traffic prediction for reducing latency will be described below.

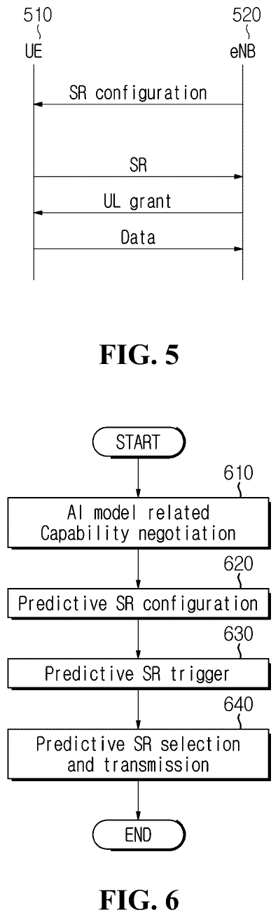

As an example, FIG. 5 is a view showing a method by which a terminal requests an uplink resource to a base station according to an embodiment of the present disclosure. Referring to FIG. 5, in an existing communication system, when data arrives at a buffer, a terminal 510 may check whether or not an uplink resource is allocated to transmit the data. If no uplink resource suitable for transmitting the data is allocated, the terminal 510 may determine that the uplink resource is not allocated and may deliver a scheduling request (SR) to request resource allocation. As an example, in FIG. 5, a base station 520 may be a gNB, but this is a configuration for convenience of explanation, and the base station 520 may be an eNB or another form and is not limited to a specific form. Hereinafter, for convenience of explanation, the following description will focus on the base station 520.

As an example, the terminal 510 may receive SR configuration information from the base station 520 through a radio resource control (RRC) message and set an SR configuration. Herein, the SR configuration may be information that is set to transmit an SR to the base station 520 on account of occurrence of data in a buffer of the terminal 510. When data occurs in the buffer, the terminal 510 may transmit an SR based on SR configuration information to the base station 520. As an example, the terminal 510 may deliver the SR to the base station 520 through a physical uplink control channel (PUCCH). As another example, the terminal 520 may deliver the SR to the base station through uplink control information (UCI), which is given as feedback to a physical uplink shared channel (PUSCH), but may not be limited to a specific form.

Next, the terminal 510 may receive a UL grant indicating an uplink resource allocated from the base station 520 and identify an uplink transmission resource. As an example, the UL grant may be delivered to the terminal 510 through downlink control information (DCI). The terminal 510 may transmit data to the base station 520 through the uplink resource.

As an example, based on what is described above, an operation for uplink data transmission may consider an operation of Table 2 below but be not limited thereto. In addition, an SR operation for requesting a resource for uplink data transmission may refer to Table 3 below but be not limited thereto.

TABLE 2
UL-SCH data transfer
UL Grant reception

Uplink grant is either received dynamically on the PDCCH, in a Random Access Response,
configured semi-persistently by RRC or determined to be associated with the PUSCH resource
of MSGA as specified in clause 5.1.2a. The MAC entity shall have an uplink grant to transmit on
the UL-SCH. To perform the requested transmissions, the MAC layer receives HARQ
information from lower layers. An uplink grant addressed to CS-RNTI with NDI = 0 is
considered as a configured uplink grant. An uplink grant addressed to CS-RNTI with NDI = 1 is
considered as a dynamic uplink grant.
If the MAC entity has a C-RNTI, a Temporary C-RNTI, or CS-RNTI, the MAC entity shall for
each PDCCH occasion and for each Serving Cell belonging to a TAG that has a running
timeAlignmentTimer and for each grant received for this PDCCH occasion:

| 1> | if an uplink grant for this Serving Cell has been received on the PDCCH for the MAC | |
|---|---|---|
| | entity's C-RNTI or Temporary C-RNTI; or | |
| 1> | if an uplink grant has been received in a Random Access Response: | |
| | 2> | if the uplink grant is for MAC entity's C-RNTI and if the previous uplink grant |
| | | delivered to the HARQ entity for the same HARQ process was either an uplink grant |
| | | received for the MAC entity's CS-RNTI or a configured uplink grant: |

| | |
|---|---|
| 3> | consider the NDI to have been toggled for the corresponding HARQ process |
| | regardless of the value of the NDI. |

| | |
|---|---|
| 2> | if the uplink grant is for MAC entity's C-RNTI, and the identified HARQ process is |
| | configured for a configured uplink grant: |

| | |
|---|---|
| 3> | start or restart the configuredGrantTimer for the corresponding HARQ process, if |
| | configured. |
| 3> | stop the cg-RetransmissionTimer for the corresponding HARQ process, if running. |

| | 2> | deliver the uplink grant and the associated HARQ information to the HARQ entity. |
|---|---|---|
| 1> | else if an uplink grant for this PDCCH occasion has been received for this Serving Cell on | |
| | the PDCCH for the MAC entity's CS-RNTI: | |
| | 2> | if the NDI in the received HARQ information is 1: |

| | |
|---|---|
| 3> | consider the NDI for the corresponding HARQ process not to have been toggled; |
| 3> | start or restart the configuredGrantTimer for the corresponding HARQ process, if |
| | configured; |
| 3> | stop the cg-RetransmissionTimer for the corresponding HARQ process, if running; |
| 3> | deliver the uplink grant and the associated HARQ information to the HARQ entity. |

| | |
|---|---|
| 2> | else if the NDI in the received HARQ information is 0; |

| | |
|---|---|
| 3> | if PDCCH contents indicate configured grant Type 2 deactivation: |

| | |
|---|---|
| 4> | trigger configured uplink grant confirmation. |

| | |
|---|---|
| 3> | else if PDCCH contents indicate configured grant Type 2 activation: |

| | |
|---|---|
| 4> | trigger configured uplink grant confirmation; |
| 4> | store the uplink grant for this Serving Cell and the associated HARQ |
| | information as configured uplink grant; |
| 4> | initialise or re-initialise the configured uplink grant for this Serving Cell to start |
| | in the associated PUSCH duration and to recur according to rules in clause |
| | 5.8.2; |
| 4> | stop the configuredGrantTimer for the corresponding HARQ process, if |
| | running; |
| 4> | stop the cg-RetransmissionTimer for the corresponding HARQ process, if |
| | running. |

For each Serving Cell and each configured uplink grant, if configured and activated, the MAC
entity shall:

| 1> | if the MAC entity is configured with lch-basedPrioritization, and the PUSCH duration of | |
|---|---|---|
| | the configured uplink grant does not overlap with the PUSCH duration of an uplink grant | |
| | received in a Random Access Response or with the PUSCH duration of an uplink grant | |
| | addressed to Temporary C-RNTI or the PUSCH duration of a MSGA payload for this | |
| | Serving Cell; or | |
| 1> | if the MAC entity is not configured with lch-basedPrioritization, and the PUSCH duration | |
| | of the configured uplink grant does not overlap with the PUSCH duration of an uplink | |
| | grant received on the PDCCH or in a Random Access Response or the PUSCH duration | |
| | of a MSGA payload for this Serving Cell: | |
| | 2> | set the HARQ Process ID to the HARQ Process ID associated with this PUSCH |
| | | duration; |
| | 2> | if, for the corresponding HARQ process, the configuredGrantTimer is not running and |
| | | cg-RetransmissionTimer is not configured (i.e. new transmission): |

| | |
|---|---|
| 3> | consider the NDI bit for the corresponding HARQ process to have been toggled; |
| 3> | deliver the configured uplink grant and the associated HARQ information to the |
| | HARQ entity. |

| | |
|---|---|
| 2> | else if the cg-RetransmissionTimer for the corresponding HARQ process is configured |
| | and not running, then for the corresponding HARQ process: |

| | |
|---|---|
| 3> | if the configuredGrantTimer is not running, and the HARQ process is not pending |
| | (i.e. new transmission): |

| | |
|---|---|
| 4> | consider the NDI bit to have been toggled; |
| 4> | deliver the configured uplink grant and the associated HARQ information to |
| | the HARQ entity. |

| | |
|---|---|
| 3> | else if the previous uplink grant delivered to the HARQ entity for the same HARQ |
| | process was a configured uplink grant (i.e. retransmission on configured grant): |

| | |
|---|---|
| 4> | deliver the configured uplink grant and the associated HARQ information to |
| | the HARQ entity. |

```
For configured uplink grants neither configured with harq-ProcID-Offset2 nor with cg-
RetransmissionTimer, the HARQ Process ID associated with the first symbol of a UL
transmission is derived from the following equation:
    HARQ Process ID = [floor(CURRENT_symbol/periodicity)] modulo nrofHARQ-Processes
For configured uplink grants with harq-ProcID-Offset2, the HARQ Process ID associated with
the first symbol of a UL transmission is derived from the following equation:
  HARQ Process ID = [floor(CURRENT_symbol / periodicity)] modulo nrofHARQ-Processes +
```

harq-ProcID-Offset2

```
where CURRENT_symbol = (SFN × numberOfSlotsPerFrame × numberOfSymbolsPerSlot + slot
number in the frame × numberOfSymbolsPerSlot + symbol number in the slot), and
numberOfSlotsPerFrame and numberOfSymbolsPerSlot refer to the number of consecutive slots
per frame and the number of consecutive symbols per slot, respectively as specified in TS 38.211
[8].
For configured uplink grants configured with cg-RetransmissionTimer, the UE implementation
selects an HARQ Process ID among the HARQ process IDs available for the configured grant
configuration. For HARQ Process ID selection, the UE shall prioritize retransmissions before
initial transmissions. The UE shall toggle the NDI in the CG-UCI for new transmissions and not
toggle the NDI in the CG-UCI in retransmissions.
  NOTE 1: CURRENT_symbol refers to the symbol index of the first transmission occasion of
          a bundle of configured uplink grant.
  NOTE 2: A HARQ process is configured for a configured uplink grant where neither harq-
          ProcID-Offset nor harq-ProcID-Offset2 is configured, if the configured uplink grant
          is activated and the associated HARQ process ID is less than nrofHARQ-Processes.
          A HARQ process is configured for a configured uplink grant where harq-ProcID-
          Offset2 is configured, if the configured uplink grant is activated and the associated
          HARQ process ID is greater than or equal to harq-ProcID-Offset2 and less than
          sum of harq-ProcID-Offset2 and nrofHARQ-Processes for the configured grant
          configuration.
  NOTE 3: If the MAC entity receives a grant in a Random Access Response (i.e. MAC RAR
          or fallbackRAR), or addressed to Temporary C-RNTI or determines a grant as
          specified in clause 5.1.2a for MSGA payload and if the MAC entity also receives an
          overlapping grant for its C-RNTI or CS-RNTI, requiring concurrent transmissions
          on the SpCell, the MAC entity may choose to continue with either the grant for its
          RA-RNTI/Temporary C-RNTI/MSGB-RNTI/the MSGA payload transmission or
          the grant for its C-RNTI or CS-RNTI.
  NOTE 4: In case of unaligned SFN across carriers in a cell group, the SFN of the concerned
          Serving Cell is used to calculate the HARQ Process ID used for configured uplink
          grants.
  NOTE 5: If cg-RetransmissionTimer is not configured, a HARQ process is not shared between
          different configured grant configurations in the same BWP.
For the MAC entity configured with lch-basedPrioritization, priority of an uplink grant is
determined by the highest priority among priorities of the logical channels that are multiplexed
(i.e. the MAC PDU to transmit is already stored in the HARQ buffer) or have data available that
can be multiplexed (i.e. the MAC PDU to transmit is not stored in the HARQ buffer) in the MAC
PDU, according to the mapping restrictions as described in clause 5.4.3.1.2. The priority of an
uplink grant for which no data for logical channels is multiplexed or can be multiplexed in the
MAC PDU is lower than either the priority of an uplink grant for which data for any logical
channels is multiplexed or can be multiplexed in the MAC PDU or the priority of the logical
channel triggering an SR.
For the MAC entity configured with lch-basedPrioritization, if the corresponding PUSCH
transmission of a configured uplink grant is cancelled by CI-RNTI as specified in clause 11.2A of
TS 38.213 [6] or cancelled by a high PHY-priority PUCCH transmission as specified in clause 9
of TS 38.213 [6], this configured uplink grant is considered as a de-prioritized uplink grant. If
this deprioritized uplink grant is configured with autonomousTx, the configuredGrantTimer for
the corresponding HARQ process of this de-prioritized uplink grant shall be stopped if it is
running.
When the MAC entity is configured with lch-basedPrioritization, for each uplink grant delivered
to the HARQ entity and whose associated PUSCH can be transmitted by lower layers, the MAC
entity shall:
```

| 1> | if this uplink grant is received in a Random Access Response (i.e. in a MAC RAR or | |
|---|---|---|
| | fallback RAR), or addressed to Temporary C-RNTI, or is determined as specified in | |
| | clause 5.1.2a for the transmission of the MSGA payload: | |
| | 2> | consider this uplink grant as a prioritized uplink grant. |
| 1> | else if this uplink grant is addressed to CS-RNTI with NDI = 1 or C-RNTI: | |
| | 2> | if there is no overlapping PUSCH duration of a configured uplink grant which was not |
| | | already de-prioritized, in the same BWP whose priority is higher than the priority of |
| | | the uplink grant; and |
| | 2> | if there is no overlapping PUCCH resource with an SR transmission which was not |
| | | already de-prioritized and the priority of the logical channel that triggered the SR is |
| | | higher than the priority of the uplink grant: |

| | |
|---|---|
| 3> | consider this uplink grant as a prioritized uplink grant; |
| 3> | consider the other overlapping uplink grant(s), if any, as a de-prioritized uplink |
| | grant(s); |

| 1> | else if this uplink grant is a configured uplink grant: | |
|---|---|---|
| | 2> | if there is no overlapping PUSCH duration of another configured uplink grant which |
| | | was not already de-prioritized, in the same BWP, whose priority is higher than the |
| | | priority of the uplink grant; and |
| | 2> | if there is no overlapping PUSCH duration of an uplink grant addressed to CS-RNTI |
| | | with NDI = 1 or C-RNTI which was not already de-prioritized, in the same BWP, |
| | | whose priority is higher than or equal to the priority of the uplink grant; and |
| | 2> | if there is no overlapping PUCCH resource with an SR transmission which was not |
| | | already de-prioritized and the priority of the logical channel that triggered the SR is |
| | | higher than the priority of the uplink grant: |

| | |
|---|---|
| 3> | consider this uplink grant as a prioritized uplink grant; |
| 3> | consider the other overlapping uplink grant(s), if any, as a de-prioritized uplink |
| | grant(s); |
| 3> | if the de-prioritized uplink grant(s) is a configured uplink grant configured with |
| | autonomousTx whose PUSCH has already started: |

| | |
|---|---|
| 4> | stop the configuredGrantTimer for the corresponding HARQ process of the de- |
| | prioritized uplink grant(s). |

| | |
|---|---|
| 3> | consider the other overlapping SR transmission(s), if any, as a de-prioritized SR |
| | transmission(s). |

```
  NOTE 6: If the MAC entity is configured with lch-basedPrioritization and if there is
          overlapping PUSCH duration of at least two configured uplink grants whose
          priorities are equal, the prioritized uplink grant is determined by UE
          implementation.
  NOTE 7: If the MAC entity is not configured with lch-basedPrioritization and if there is
          overlapping PUSCH duration of at least two configured uplink grants, it is up to
          UE implementation to choose one of the configured uplink grants.
  NOTE 8: If the MAC entity is configured with lch-basedPrioritization, the MAC entity does
          not take UCI multiplexing according to the procedure specified in TS 38.213 [6]
          into account when determining whether the PUSCH duration of an uplink grant
          overlaps with the PUCCH resource for an SR transmission.
```

TABLE 3
Scheduling Request

The Scheduling Request (SR) is used for
requesting UL-SCH resources for new transmission.
The MAC entity may be configured with zero,
one, or more SR configurations. An SR
configuration consists of a set of PUCCH resources
for SR across different BWPs and cells. For a
logical channel or for SCell beam failure recovery
(see clause 5.17) and for consistent LBT
failure recovery (see clause 5.21), at most one
PUCCH resource for SR is configured per BWP.
Each SR configuration corresponds to one or more
logical channels and/or to SCell beam failure
recovery and/or to consistent LBT failure recovery.
Each logical channel, SCell beam failure
recovery, and consistent LBT failure recovery, may be
mapped to zero or one SR configuration,
which is configured by RRC. The SR configuration
of the logical channel that triggered a BSR
(clause 5.4.5) or the SCell beam failure recovery
or the consistent LBT failure recovery (clause
5.21) (if such a configuration exists) is considered
as corresponding SR configuration for the
triggered SR. Any SR configuration may be used
for an SR triggered by Pre-emptive BSR
(clause 5.4.7).
RRC configures the following parameters
for the scheduling request procedure:

| | |
|---|---|
| - | sr-ProhibitTimer (per SR configuration); |
| - | sr-TransMax (per SR configuration). |

The following UE variables are used for the scheduling request procedure:

| | |
|---|---|
| - | SR_COUNTER (per SR configuration). |

If an SR is triggered and there are no other SRs pending corresponding to the same SR
configuration, the MAC entity shall set the SR_COUNTER of the corresponding SR
configuration to 0.
When an SR is triggered, it shall be considered as pending until it is cancelled.
All pending SR(s) for BSR triggered according to the BSR procedure (clause 5.4.5) prior to the
MAC PDU assembly shall be cancelled and each respective sr-ProhibitTimer shall be stopped
when the MAC PDU is transmitted and this PDU includes a Long or Short BSR MAC CE which
contains buffer status up to (and including) the last event that triggered a BSR (see clause 5.4.5)
prior to the MAC PDU assembly. All pending SR(s) for BSR triggered according to the BSR
procedure (clause 5.4.5) shall be cancelled and each respective sr-ProhibitTimer shall be stopped
when the UL grant(s) can accommodate all pending data available for transmission.
The MAC entity shall for each pending SR not triggered according to the BSR procedure (clause
5.4.5) for a Serving Cell:

| | |
|---|---|
| 1> | if this SR was triggered by Pre-emptive BSR |
| | procedure (see clause 5.4.7) prior to the |
| | MAC PDU assembly and a MAC PDU containing |
| | the relevant Pre-emptive BSR MAC CE |
| | is transmitted; or |
| 1> | if this SR was triggered by beam failure recovery |
| | (see clause 5.17) of an SCell and a MAC |
| | PDU is transmitted and this PDU includes a BFR |
| | MAC CE or a Truncated BFR MAC CE |
| | which contains beam failure recovery information for this SCell; or |
| 1> | if this SR was triggered by beam failure recovery |
| | (see clause 5.17) of an SCell and this |
| | SCell is deactivated (see clause 5.9); or |

| | |
|---|---|
| 1> | if this SR was triggered by consistent LBT failure |
| | recovery (see clause 5.21) of an SCell |
| | and a MAC PDU is transmitted and the MAC PDU |
| | includes an LBT failure MAC CE that |
| | indicates consistent LBT failure for this SCell; or |
| 1> | if this SR was triggered by consistent LBT |
| | failure recovery (see clause 5.21) of an SCell |
| | and all the triggered consistent LBT failure(s) |
| | for this SCell are cancelled: |

| | |
|---|---|
| 2> | cancel the pending SR and stop the |
| | corresponding sr-ProhibitTimer, if running. |

Only PUCCH resources on a BWP which is active at the time of SR transmission occasion are
considered valid.
As long as at least one SR is pending, the MAC entity shall for each pending SR:

| | |
|---|---|
| 1> | if the MAC entity has no valid PUCCH |
| | resource configured for the pending SR: |

| | |
|---|---|
| 2> | initiate a Random Access procedure |
| | (sec clause 5.1) on the SpCell and cancel the |
| | pending SR. |

| | |
|---|---|
| 1> | else, for the SR configuration corresponding to the pending SR: |

| | |
|---|---|
| 2> | when the MAC entity has an SR transmission |
| | occasion on the valid PUCCH resource. |
| | for SR configured; and |
| 2> | if sr-ProhibitTimer is not running at the time of the SR transmission occasion; and |
| 2> | if the PUCCH resource for the SR transmission occasion does not overlap with a |
| | measurement gap: |

| | |
|---|---|
| 3> | if the PUCCH resource for the SR transmission |
| | occasion overlaps with neither a |
| | UL-SCH resource nor an SL-SCH resource; or |
| 3> | if the MAC entity is able to perform this SR transmission simultaneously with the |
| | transmission of the SL-SCH resources or |
| 3> | if the MAC entity is configured with lch-basedPrioritization, and the PUCCH |
| | resource for the SR transmission occasion does not overlap with the PUSCH |
| | duration of an uplink grant received in a Random Access Response or with the |
| | PUSCH duration of an uplink grant addressed to Temporary C-RNTI or with the |
| | PUSCH duration of a MSGA payload, and the PUCCH resource for the SR |
| | transmission occasion for the pending SR triggered as specified in clause 5.4.5 |
| | overlaps with any other UL-SCH resource(s), and the physical layer can signal the |
| | SR on one valid PUCCH resource for SR, and the |
| | priority of the logical channel |
| | that triggered SR is higher than the priority of the uplink grant(s) for any UL-SCH. |
| | resource(s) where the uplink grant was not already de-prioritized, and the priority |
| | of the uplink grant is determined as specified in clause 5.4.1; or |
| 3> | if both sl-PrioritizationThres and ul-PrioritizationThres are configured and the |
| | PUCCH resource for the SR transmission occasion for the pending SR triggered as |
| | specified in clause 5.22.1.5 overlaps with any UL-SCH resource(s) carrying a MAC |
| | PDU, and the value of the priority of the triggered SR determined as specified in |
| | clause 5.22.1.5 is lower than sl-PrioritizationThres and the value of the highest |
| | priority of the logical channel(s) in the MAC PDU is higher than or equal to ul- |
| | PrioritizationThres and any MAC CE prioritized as described in clause 5.4.3.1.3 is |
| | not included in the MAC PDU and the MAC PDU is not prioritized by upper layer |
| | according to TS 23.287 [19]; or |
| 3> | if a SL-SCH resource overlaps with the PUCCH resource for the SR transmission |
| | occasion for the pending SR triggered as specified in clause 5.4.5, and the MAC |
| | entity is not able to perform this SR transmission simultaneously with the |
| | transmission of the SL-SCH resource, and either transmission on the SL-SCH |
| | resource is not prioritized as described in clause 5.22.1.3.1a or the priority value of |
| | the logical channel that triggered SR is lower than ul-PrioritizationThres, if |
| | configured; or |
| 3> | if a SL-SCH resource overlaps with the PUCCH resource for the SR transmission |
| | occasion for the pending SR triggered as specified in clause 5.22.1.5, and the MAC |
| | entity is not able to perform this SR transmission simultaneously with the |
| | transmission of the SL-SCH resource, and the priority of the triggered SR |
| | determined as specified in clause 5.22.1.5 is higher than the priority of the MAC |
| | PDU determined as specified in clause 5.22.1.3.1a for the SL-SCH resource: |

| | |
|---|---|
| 4> | consider the SR transmission as a prioritized SR transmission. |
| 4> | consider the other overlapping uplink grant(s), |
| | if any, as a de-prioritized uplink |
| | grant(s); |
| 4> | if the de-prioritized uplink grant(s) is a |
| | configured uplink grant configured with |
| | autonomousTx whose PUSCH has already started: |

| | |
|---|---|
| 5> | stop the configuredGrantTimer for the |
| | corresponding HARQ process of the |
| | de-prioritized uplink grant(s). |

| | |
|---|---|
| 4> | if SR_COUNTER < sr-TransMax: |

| | |
|---|---|
| 5> | instruct the physical layer to signal |
| | the SR on one valid PUCCH resource for |
| | SR; |
| 5> | if LBT failure indication is not |
| | received from lower layers: |

| | |
|---|---|
| 6> | increment SR_COUNTER by 1; |
| 6> | start the sr-ProhibitTimer. |

| | |
|---|---|
| 5> | else if lbt-FailureRecoveryConfig is not configured: |

| | |
|---|---|
| 6> | increment SR_COUNTER by 1. |

| | |
|---|---|
| 4> | else: |

| | |
|---|---|
| 5> | notify RRC to release PUCCH for all Serving Cells; |
| 5> | notify RRC to release SRS for all Serving Cells; |
| 5> | clear any configured downlink assignments and uplink grants; |
| 5> | clear any PUSCH resources for semi-persistent CSI reporting: |
| 5> | initiate a Random Access procedure (see clause 5.1) |
| | on the SpCell and cancel |
| | all pending SRs. |

| | |
|---|---|
| 3> | else: |

| | |
|---|---|
| 4> | consider the SR transmission as |
| | a de-prioritized SR transmission. |

| NOTE 1: | Except for SR for SCell beam failure recovery, the selection of which valid PUCCH |
|---|---|
| | resource for SR to signal SR on when the MAC entity has more than one |
| | overlapping valid PUCCH resource for the SR transmission occasion is left to UE |
| | implementation. |
| NOTE 2: | If more than one individual SR triggers an instruction from the MAC entity to the |
| | PHY layer to signal the SR on the same valid PUCCH resource, the SR_COUNTER |
| | for the relevant SR configuration is incremented only once. |
| NOTE 3: | When the MAC entity has pending SR for SCell beam failure recovery and the |
| | MAC entity has one or more PUCCH resources overlapping with PUCCH resource |
| | for SCell beam failure recovery for the SR transmission occasion, the MAC entity |
| | considers only the PUCCH resource for SCell beam failure recovery as valid. |
| NOTE 4: | For a UE operating in a semi-static channel access mode as described in TS 37.213 |
| | [18], PUCCH resources overlapping with the set of consecutive symbols where the |
| | UE does not transmit before the start of a next channel occupancy time are not |
| | considered valid. |
| NOTE 5: | If the MAC entity is configured with lch-basedPrioritization, the MAC entity does |

not take UCI multiplexing according to the procedure specified in TS 38.213 [6]
into account when determining whether the valid PUCCH resource for the SR
transmission can be signalled by the physical layer and the SR transmission
occasion overlaps with the PUSCH duration of an uplink grant of a MSGA
payload.

The MAC entity may stop, if any, ongoing Random Access procedure due to a pending SR for
BSR, which was initiated by the MAC entity prior
to the MAC PDU assembly and which has no
valid PUCCH resources configured, if:

| | |
|---|---|
| - | a MAC PDU is transmitted using a UL grant other than a UL grant provided by Random |
| | Access Response or a UL grant determined as specified in clause 5.1.2a for the |
| | transmission of the MSGA payload, and this PDU includes a BSR MAC CE which |
| | contains buffer status up to (and including) the last event that triggered a BSR (see clause |
| | 5.4.5) prior to the MAC PDU assembly; or |
| - | the UL grant(s) can accommodate all pending data available for transmission. |

The MAC entity may stop, if any, ongoing Random Access procedure due to a pending SR for
SL-BSR and/or SL-CSI reporting, which was initiated by the MAC entity prior to the sidelink
MAC PDU assembly and which has no valid PUCCH resources configured, if:

| | |
|---|---|
| - | a MAC PDU is transmitted using a UL grant other than a UL grant provided by Random |
| | Access Response or a UL grant determined as specified in clause 5.1.2a for the |
| | transmission of the MSGA payload, and this PDU includes a SL-BSR MAC CE which |
| | contains buffer status up to (and including) the last event that triggered a SL-BSR (see |
| | clause 5.22.1.6) prior to the MAC PDU assembly; or |
| - | the SL grant(s) can accommodate all pending data available and/or SL-CSI reporting |
| | MAC CE for transmission. |

The MAC entity may stop, if any, ongoing Random Access procedure due to a pending SR for
BFR of an SCell, which has no valid PUCCH resources configured, if:

| | |
|---|---|
| - | a MAC PDU is transmitted using a UL grant other than a UL grant provided by Random |
| | Access Response or a UL grant determined as specified in clause 5.1.2a for the |
| | transmission of the MSGA payload, and this PDU contains a BER MAC CE or a |
| | Truncated BFR MAC CE which includes beam failure recovery information of that SCell; |
| | or |
| - | the SCell is deactivated (as specified in clause 5.9) and all triggered BERs for SCells are |
| | cancelled. |

The MAC entity may stop, if any, ongoing Random Access procedure due to a pending SR for
consistent LBT failure recovery, which has no valid PUCCH resources configured, if:

| | |
|---|---|
| - | a MAC PDU is transmitted using a UL grant other than a UL grant provided by Random |
| | Access Response or a UL grant determined as specified in clause 5.1.2a for the |
| | transmission of the MSGA payload, and this PDU includes an LBT failure MAC CE that |
| | indicates consistent LBT failure for all the SCells that triggered consistent LBT failure; or |

| | |
|---|---|
| - | all the SCells that triggered consistent LBT failure |
| | recovery are deactivated (see clause 5.9). |

In addition, as an example, in an existing communication system (e.g., 5G system), multiple SRs may be set in the terminal 510. The terminal 510 may inform the base station 520 of arrival of data, which is urgent data with a higher priority, based on a priority order of arrived data. Herein, in case there are multiple SR settings, when data with a high priority arrives, the terminal 510 may quickly request uplink resource allocation to the base station 520 based on the multiple SRs, thereby reducing latency. However, even based on the above-described operation, as the terminal 510 requests an uplink resource for data transmission after occurrence of data in a buffer, is allocated the uplink resource based on the request, and then performs data transmission, latency is unavoidable.

Herein, as an example, in order to reduce likely latency for URLLC traffic, a base station may allocate a configured grant to a terminal. However, as the configured grant periodically allocates a resource, resource extravagance may occur. In addition, sporadic URLLC data may be difficult to process by the configured grant, and based on what is described above, a method for performing resource request based on traffic prediction will be described below.

Meanwhile, as an example, regarding uplink data transmission, a terminal may report information on data arrived at a buffer to a base station, which may be performed based on a buffer status report (BSR). Herein, the BSR may operate based on Table 4 below but not limited thereto. In addition, as an example, for uplink data transmission of a terminal, retransmission may be required, and the retransmission may be performed based on a hybrid automatic repeat and request (HARQ) operation. As an example, a plurality of parallel HARQ processes may be configured in a terminal, and data transmission and retransmission may be performed based on each HARQ process. As an example, the HARQ operation may be performed based on Table 5 below but not be limited thereto.

TABLE 4
Buffer Status Reporting

The Buffer Status reporting (BSR) procedure is used to provide the serving gNB with
information about UL data volume in the MAC entity.
RRC configures the following parameters to control the BSR:

| | |
|---|---|
| - | periodicBSR-Timer; |
| - | vetxBSR-Timer; |
| - | logicalChannelSR-DelayTimerApplied; |
| - | logicalChannelSR-DelayTimer; |
| - | logicalChannelSR-Mask; |
| - | logicalChannelGroup. |

Each logical channel may be allocated to an LCG using the logicalChannelGroup. The maximum
number of LCGs is eight.
The MAC entity determines the amount of UL data available for a logical channel according to
the data volume calculation procedure in TSs 38.322 [3] and 38.323 [4].
A BSR shall be triggered if any of the following events occur:

| | |
|---|---|
| - | UL data, for a logical channel which belongs to an LCG, becomes available to the MAC. |
| | entity; and either |

| | |
|---|---|
| - | this UL data belongs to a logical channel with higher priority than the priority of any |
| | logical channel containing available UL data which belong to any LCG; or |
| - | none of the logical channels which belong to an LCG contains any available UL data. |

| | |
|---|---|
| | in which case the BSR is referred below to as ‘Regular BSR’; |
| - | UL resources are allocated and number of padding bits is equal to or larger than the size |
| | of the Buffer Status Report MAC CE plus its subheader, in which case the BSR is referred |
| | below to as ‘Padding BSR'; |
| - | retxBSR-Timer expires, and at least one of the logical channels which belong to an LCG |
| | contains UL data, in which case the BSR is referred below to as ‘Regular BSR’; |
| - | periodicBSR-Timer expires, in which case the BSR is referred below to as ‘Periodic BSR’. |

| | |
|---|---|
| NOTE 1: | When Regular BSR triggering events occur for multiple logical channels |

simultaneously, each logical channel triggers one separate Regular BSR.

For Regular BSR, the MAC entity shall:

| | |
|---|---|
| 1> | if the BSR is triggered for a logical channel for which logicalChannelSR- |
| | DelayTimerApplied with value true is configured by upper layers: |

| | |
|---|---|
| 2> | start or restart the logicalChannelSR-DelayTimer. |

| | |
|---|---|
| 1> | else: |

| | |
|---|---|
| 2> | if running, stop the logicalChannelSR-DelayTimer, |
| | For Regular and Periodic BSR, the MAC entity shall: |

| | |
|---|---|
| 1> | if more than one LCG has data available for transmission when the MAC PDU containing |
| | the BSR is to be built: |

| | |
|---|---|
| 2> | report Long BSR for all LCGs which have data available for transmission. |

| | |
|---|---|
| 1> | else: |

| | |
|---|---|
| 2> | reportShort BSR. |

For Padding BSR, the MAC entity shall:

| | |
|---|---|
| 1> | if the number of padding bits is equal to or larger than the size of the Short BSR plus its |
| | subheader but smaller than the size of the Long BSR plus its subheader: |

| | |
|---|---|
| 2> | if more than one LCG has data available for transmission when the BSR is to be built: |

| | |
|---|---|
| 3> | if the number of padding bits is equal to the size of the Short BSR plus its |
| | subheader: |

| | |
|---|---|
| 4> | report Short Truncated BSR of the LCG with the highest priority logical |
| | channel with data available for transmission. |

| | |
|---|---|
| 3> | else: |

| | |
|---|---|
| 4> | report Long Truncated BSR of the LCG(s) with the logical channels having data |
| | available for transmission following a decreasing order of the highest priority |
| | logical channel (with or without data available for transmission) in each of these |
| | LCG(s), and in case of equal priority, in increasing order of LCGID. |

| | |
|---|---|
| 2> | else: |

| | |
|---|---|
| 3> | report Short BSR. |

| | |
|---|---|
| 1> | else if the number of padding bits is equal to or larger than the size of the Long BSR plus |
| | its subheader: |

| | |
|---|---|
| 2> | report Long BSR for all LCGs which have data available for transmission. |

For BSR triggered by retxBSR-Timer expiry, the MAC entity considers that the logical channel
that triggered the BSR is the highest priority logical channel that has data available for
transmission at the time the BSR is triggered.
The MAC entity shall:

| | |
|---|---|
| 1> | if the Buffer Status reporting procedure determines that at least one BSR has been |
| | triggered and not cancelled: |

| | |
|---|---|
| 2> | if UL-SCH resources are available for a new transmission and the UL-SCH resources |
| | can accommodate the BSR MAC CE plus its subheader as a result of logical channel |
| | prioritization: |

| | |
|---|---|
| 3> | instruct the Multiplexing and Assembly procedure to generate the BSR MAC CE(s) |
| | as defined in clause 6.1.3.1; |
| 3> | start or restart periodicBSR-Timer except when all the generated BSRs are long or |
| | short Truncated BSRs; |
| 3> | start or restart retxBSR-Timer, |

| | |
|---|---|
| 2> | if a Regular BSR has been triggered and logicalChannelSR-DelayTimer is not running; |

| | |
|---|---|
| 3> | if there is no UL-SCH resource available for a new transmission; or |
| 3> | if the MAC entity is configured with configured uplink grant(s) and the Regular |
| | BSR was triggered for a logical channel for which logicalChannelSR-Mask is set to |
| | false; or |
| 3> | if the UL-SCH resources available for a new transmission do not meet the LCP |
| | mapping restrictions (see clause 5.4.3.1) configured for the logical channel that |
| | triggered the BSR: |

| | |
|---|---|
| 4> | trigger a Scheduling Request. |

| | |
|---|---|
| NOTE 2: | UL-SCH resources are considered available if the MAC entity has been configured |

with, receives, or determines an uplink grant. If the MAC entity has determined at
a given point in time that UL-SCH resources are available, this need not imply that
UL-SCH resources are available for use at that point in time.

A MAC PDU shall contain at most one BSR MAC CE, even when multiple events have triggered
a BSR. The Regular BSR and the Periodic BSR shall have precedence over the padding BSR.
The MAC entity shall restart retxBSR-Timer upon reception of a grant for transmission of new
data on any UL-SCH.
All triggered BSRs may be cancelled when the UL grant(s) can accommodate all pending data
available for transmission but is not sufficient to additionally accommodate the BSR MAC CE
plus its subheader. All BSRs triggered prior to MAC PDU assembly shall be cancelled when a
MAC PDU is transmitted and this PDU includes a Long or Short BSR MAC CE which contains
buffer status up to (and including) the last event that triggered a BSR prior to the MAC PDU
assembly.

| NOTE 3: | MAC PDU assembly can happen at any point in time between uplink grant |
|---|---|
| | reception and actual transmission of the corresponding MAC PDU. BSR and SR |
| | can be triggered after the assembly of a MAC PDU which contains a BSR MAC |
| | CE, but before the transmission of this MAC PDU. In addition, BSR and SR can be |
| | triggered during MAC PDU assembly. |
| NOTE 4: | Void |
| NOTE 5: | If a HARQ process is configured with eg-RetransmissionTimer and if the BSR is |

already included in a MAC PDU for transmission on configured grant by this
HARQ process, but not yet transmitted by lower layers, it is up to UE
implementation how to handle the BSR content.

TABLE 5
HARQ operation
HARQ Entity

The MAC entity includes
a HARQ entity for each
Serving Cell with configured
uplink (including
the case when it is configured
with supplementaryUplink),
which maintains a number of parallel
HARQ processes.
The number of parallel UL HARQ processes
per HARQ entity is specified in TS 38.214 [7].
Each HARQ process supports one TB.
Each HARQ process is associated with a HARQ process
identifier. For UL transmission with UL
grant in RA Response or for UL transmission for
MSGA payload, HARQ process identifier 0 is
used.

| | |
|---|---|
| NOTE: | When a single DCI is used to schedule multiple |

PUSCH, the UE is allowed to map
generated TB(s) internally to different
HARQ processes in case of LBT failure(s),
i.e. UE may transmit a new TB on any
HARQ process in the grants that have the
same TBS, the same RV and the NDIs
indicate new transmission.

The maximum number of transmissions of a TB within a bundle of the dynamic grant or
configured grant is given by REPETITION_NUMBER as follows:

| | |
|---|---|
| - | For a dynamic grant, |
| | REPETITION_NUMBER is |
| | set to a value provided |
| | by lower layers, |
| | as specified in clause |
| | 6.1.2.1 of TS 38.214 [7]; |
| - | For a configured grant, |
| | REPETITION_NUMBER |
| | is set to a value |
| | provided by lower |
| | layers, as specified in |
| | clause 6.1.2.3 of TS 38.214 [7]. |

If REPETITION_NUMBER > 1, after the first
transmission within a bundle, at most
REPETITION_NUMBER − 1 HARQ retransmissions
follow within the bundle. For both
dynamic grant and configured uplink grant, bundling
operation relies on the HARQ entity for
invoking the same HARQ process for each transmission
that is part of the same bundle. Within a
bundle, HARQ retransmissions are triggered
without waiting for feedback from previous
transmission according to REPETITION_NUMBER for
a dynamic grant or configured uplink
grant unless they are terminated as specified
in clause 6.1 of TS 38.214 [7]. Each transmission
within a bundle is a separate uplink
grant delivered to the HARQ entity.
For each transmission within a bundle of the
dynamic grant, the sequence of redundancy
versions is determined according to clause
6.1.2.1 of TS 38.214 [7]. For each transmission within
a bundle of the configured uplink grant, the
sequence of redundancy versions is determined
according to clause 6.1.2.3 of TS 38.214 [7].
For each uplink grant, the HARQ entity shall:

| | |
|---|---|
| 1> | identify the HARQ process associated with |
| | this grant, and for each identified HARQ |
| | process: |

| | |
|---|---|
| 2> | if the received grant was not addressed to a Temporary C-RNTI on PDCCH, and the |
| | NDI provided in the associated HARQ information has been toggled compared to the |
| | value in the previous transmission of this TB of this HARQ process; or |
| 2> | if the uplink grant was received on PDCCH for the C-RNTI and the HARQ buffer of |
| | the identified process is empty; or |
| 2> | if the uplink grant was received in a Random Access Response (i.e. in a MAC RAR or |
| | a fallback RAR); or |

| | |
|---|---|
| 2> | if the uplink grant was determined as specified |
| | in clause 5.1.2a for the transmission of |
| | the MSGA payload; or |
| 2> | if the uplink grant was received on PDCCH |
| | for the C-RNTI in ra-ResponseWindow |
| | and this PDCCH successfully completed the |
| | Random Access procedure initiated for |
| | beam failure recovery; or |
| 2> | if the uplink grant is part of a bundle of the |
| | configured uplink grant, and may be used |
| | for initial transmission according to |
| | clause 6.1.2.3 of TS 38.214 , and if no MAC |
| | PDU has been obtained for this bundle: |

| | |
|---|---|
| 3> | if there is a MAC PDU in the MSGA buffer |
| | and the uplink grant determined as |
| | specified in clause 5.1.2a for the transmission |
| | of the MSGA payload was selected; |
| | or |
| 3> | if there is a MAC PDU in the MSGA buffer |
| | and the uplink grant was received in a |
| | fallbackRAR and this fallbackRAR |
| | successfully completed the Random Access |
| | procedure: |

| | |
|---|---|
| 4> | obtain the MAC PDU to transmit from the MSGA buffer. |

| | |
|---|---|
| 3> | else if there is a MAC PDU in the Msg3 buffer |
| | and the uplink grant was received in |
| | a fallbackRAR: |

| | |
|---|---|
| 4> | obtain the MAC PDU to transmit from the Msg3 buffer. |

| | |
|---|---|
| 3> | else if there is a MAC PDU in the Msg3 |
| | buffer and the uplink grant was received in |
| | a MAC RAR; or: |
| 3> | if there is a MAC PDU in the Msg3 buffer |
| | and the uplink grant was received on |
| | PDCCH for the C-RNTI in ra-ResponseWindow |
| | and this PDCCH successfully |
| | completed the Random Access procedure |
| | initiated for beam failure recovery: |

| | |
|---|---|
| 4> | obtain the MAC PDU to transmit |
| | from the Msg3 buffer. |
| 4> | if the uplink grant size does not match |
| | with size of the obtained MAC PDU; and |
| 4> | if the Random Access procedure was successfully |
| | completed upon receiving the |
| | uplink grant: |

| | |
|---|---|
| 5> | indicate to the Multiplexing and |
| | assembly entity to include MAC subPDU(s) |
| | carrying MAC SDU from the obtained MAC |
| | PDU in the subsequent uplink. |
| | transmission; |
| 5> | obtain the MAC PDU to transmit |
| | from the Multiplexing and assembly |
| | entity. |

| | |
|---|---|
| 3> | else if this uplink grant is a configured |
| | grant configured with autonomousTx; and |
| 3> | if the previous configured uplink grant, |
| | in the BWP, for this HARQ process was |
| | not prioritized; and |
| 3> | if a MAC PDU had already been |
| | obtained for this HARQ process; and |
| 3> | if the uplink grant size matches |
| | with size of the obtained MAC PDU; and |
| 3> | if none of PUSCH transmission(s) of the |
| | obtained MAC PDU has been completely |
| | performed: |

| | |
|---|---|
| 4> | consider the MAC PDU has been obtained. |

| | |
|---|---|
| 3> | else if the MAC entity is not configured with lch-basedPrioritization; or |
| 3> | if this uplink grant is a prioritized uplink grant: |

| | |
|---|---|
| 4> | obtain the MAC PDU to transmit from |
| | the Multiplexing and assembly entity, if |
| | any; |

| | |
|---|---|
| 3> | if a MAC PDU to transmit has been obtained: |

| | |
|---|---|
| 4> | if the uplink grant is not a configured |
| | grant configured with autonomousTx; or |
| 4> | if the uplink grant is a |
| | prioritized uplink grant: |

| | |
|---|---|
| 5> | deliver the MAC PDU and the uplink |
| | grant and the HARQ information of |
| | the TB to the identified HARQ process; |
| 5> | instruct the identified HARQ process to |
| | trigger a new transmission; |
| 5> | if the uplink grant is a |
| | configured uplink grant: |

| | |
|---|---|
| 6> | start or restart the configuredGrantTimer, |
| | if configured, for the |
| | corresponding HARQ process when the |
| | transmission is performed if |
| | LBT failure indication is not |
| | received from lower layers; |
| 6> | start or restart the cg-RetransmissionTimer, |
| | if configured, for the |
| | corresponding HARQ process when |
| | the transmission is performed if |
| | LBT failure indication is not |
| | received from lower layers. |

| | |
|---|---|
| 5> | if the uplink grant is addressed to C-RNTI, |
| | and the identified HARQ process |
| | is configured for a configured uplink grant: |

| | |
|---|---|
| 6> | start or restart the configuredGrantTimer, |
| | if configured, for the |
| | corresponding HARQ process |
| | when the transmission is performed if |
| | LBT failure indication is not |
| | received from lower layers. |

| | |
|---|---|
| 5> | if cg-RetransmissionTimer is configured |
| | for the identified HARQ process; |
| | and |
| 5> | if the transmission is performed and LBT |
| | failure indication is received from |
| | lower layers: |

| | |
|---|---|
| 6> | consider the identified HARQ process as pending. |

| | |
|---|---|
| 3> | else: |

| | |
|---|---|
| 4> | flush the HARQ buffer of the identified HARQ process. |

| | |
|---|---|
| 2> | else (i.e. retransmission): |

| | |
|---|---|
| 3> | if the uplink grant received on PDCCH |
| | was addressed to CS-RNTI and if the |
| | HARQ buffer of the identified |
| | process is empty; or |
| 3> | if the uplink grant is part of a bundle and |
| | if no MAC PDU has been obtained for |
| | this bundle; or |
| 3> | if the uplink grant is part of a bundle of the |
| | configured uplink grant, and the |
| | PUSCH duration of the uplink grant overlaps |
| | with an uplink grant received in a |
| | Random Access Response (i.e. MAC RAR or |
| | fallbackRAR) or an uplink grant |
| | determined as specified in clause 5.1.2a for |
| | MSGA payload for this Serving Cell; |
| | or: |
| 3> | if the MAC entity is not configured with |
| | lch-basedPrioritization and this uplink |
| | grant is part of a bundle of the configured |
| | uplink grant, and the PUSCH duration |
| | of the uplink grant overlaps with a |
| | PUSCH duration of another uplink grant |
| | received on the PDCCH; or: |
| 3> | if the MAC entity is configured with |
| | lch-basedPrioritization and this uplink grant is |
| | not a prioritized uplink grant: |

| | |
|---|---|
| 4> | ignore the uplink grant. |

| | |
|---|---|
| 3> | else: |

| | |
|---|---|
| 4> | deliver the uplink grant and the HARQ |
| | information (redundancy version) of the |
| | TB to the identified HARQ process; |
| 4> | instruct the identified HARQ process |
| | to trigger a retransmission; |
| 4> | if the uplink grant is addressed to CS-RNTI; or |
| 4> | if the uplink grant is addressed to C-RNTI, |
| | and the identified HARQ process is |
| | configured for a configured uplink grant: |

| | |
|---|---|
| 5> | start or restart the configured |
| | GrantTimer, if configured, for the |
| | corresponding HARQ process when |
| | the transmission is performed if LBT |
| | failure indication is not |
| | received from lower layers. |

| | |
|---|---|
| 4> | if the uplink grant is a configured uplink grant: |

| | |
|---|---|
| 5> | if the identified HARQ process is pending: |

| | |
|---|---|
| 6> | start or restart the configuredGrantTimer, |
| | if configured, for the |
| | corresponding HARQ process when the |
| | transmission is performed if |
| | LBT failure indication is not |
| | received from lower layers; |

| | |
|---|---|
| 5> | start or restart the cg-RetransmissionTimer, |
| | if configured, for the |
| | corresponding HARQ process when |
| | the transmission is performed if LBT |
| | failure indication is not |
| | received from lower layers. |

| | |
|---|---|
| 4> | if the identified HARQ process is pending |
| | and the transmission is performed |
| | and LBT failure indication is not |
| | received from lower layers: |

| | |
|---|---|
| 5> | consider the identified HARQ |
| | process as not pending. |

When determining if NDI has been toggled compared
to the value in the previous transmission
the MAC entity shall ignore NDI received in all
uplink grants on PDCCH for its Temporary C-
RNTI.
When configuredGrantTimer or eg-RetransmissionTimer
is started or restarted by a PUSCH
transmission, it shall be started at the beginning
of the first symbol of the PUSCH transmission.
HARQ process
Each HARQ process is associated with a HARQ buffer.
New transmissions are performed on the
resource and with the MCS indicated on PDCCH or
indicated in the Random Access Response (i.e.
MAC RAR or fallbackRAR), or signalled in RRC
or determined as specified in clause 5.1.2a
for MSGA payload. Retransmissions are performed
on the resource and, if provided, with the
MCS indicated on PDCCH, or on the same resource
and with the same MCS as was used for last
made transmission attempt within a bundle, or on
stored configured uplink grant resources and
stored MCS when eg-RetransmissionTimer is
configured. If cg-RetransmissionTimer is
configured, retransmissions with the same HARQ
process may be performed on any configured
grant configuration if the configured grant
configurations have the same TBS.
When cg-RetransmissionTimer is configured
and the HARQ entity obtains a MAC PDU to
transmit and LBT failure indication is received
from lower layer, the corresponding HARQ
process is considered to be pending. For a
configured uplink grant, configured with eg-
RetransmissionTimer, each associated HARQ
process is considered as not pending when:

| | |
|---|---|
| - | a transmission is performed on that HARQ |
| | process and LBT failure indication is not |
| | received from lower layers; or |
| - | the configured uplink grant is initialised |
| | and this HARQ process is not associated with |
| | another active configured uplink grant; or |
| - | the HARQ buffer for this HARQ process is flushed. |

If the HARQ entity requests a new transmission
for a TB, the HARQ process shall:

| | |
|---|---|
| 1> | store the MAC PDU in the associated HARQ buffer; |
| 1> | store the uplink grant received from the HARQ entity; |
| 1> | generate a transmission as described below. |

If the HARQ entity requests a retransmission for a TB, the HARQ process shall:

| | |
|---|---|
| 1> | store the uplink grant received from the HARQ entity; |
| 1> | generate a transmission as described below. |

To generate a transmission for a TB, the HARQ process shall:

| | |
|---|---|
| 1> | if the MAC PDU was obtained from the Msg3 buffer; or |
| 1> | if the MAC PDU was obtained from the MSGA buffer; or |
| 1> | if there is no measurement gap at the time |
| | of the transmission and, in case of |
| | retransmission, the retransmission does not |
| | collide with a transmission for a MAC PDU |
| | obtained from the Msg3 buffer or the MSGA buffer: |

| | |
|---|---|
| 2> | if there are neither transmission of NR |
| | sidelink communication nor transmission of |
| | V2X sidelink communication at the |
| | time of the transmission; or |
| 2> | if the transmission of the MAC PDU is prioritized |
| | over sidelink transmission or can be |
| | simultaneously performed with sidelink transmission: |

| | |
|---|---|
| 3> | instruct the physical layer to generate a |
| | transmission according to the stored uplink |
| | grant. |

If a HARQ process receives downlink feedback
information, the HARQ process shall:

| | |
|---|---|
| 1> | stop the eg-RetransmissionTimer, if running; |
| 1> | if acknowledgement is indicated: |

| | |
|---|---|
| 2> | stop the configuredGrantTimer, if running. |

If the configuredGrantTimer expires
for a HARQ process, the HARQ process shall:
stored configured uplink grant resources
and stored MCS when eg-Retransmission Timer is
configured. If cg-RetransmissionTimer is
configured, retransmissions with the same HARQ
process may be performed on any configured
grant configuration if the configured grant
configurations have the same TBS.
When cg-RetransmissionTimer is configured
and the HARQ entity obtains a MAC PDU to
transmit and LBT failure indication is
received from lower layer, the corresponding HARQ
process is considered to be pending. For a
configured uplink grant, configured with eg-
RetransmissionTimer, each associated HARQ
process is considered as not pending when:

| | |
|---|---|
| - | a transmission is performed on that HARQ |
| | process and LBT failure indication is not |
| | received from lower layers; or |
| - | the configured uplink grant is initialised and |
| | this HARQ process is not associated with |
| | another active configured uplink grant; or |
| - | the HARQ buffer for this HARQ process is flushed. |

If the HARQ entity requests a new transmission
for a TB, the HARQ process shall:

| | |
|---|---|
| 1> | store the MAC PDU in the associated HARQ buffer; |
| 1> | store the uplink grant received from the HARQ entity; |
| 1> | generate a transmission as described below. |

If the HARQ entity requests a retransmission
for a TB, the HARQ process shall:

| | |
|---|---|
| 1> | store the uplink grant received from the HARQ entity; |
| 1> | generate a transmission as described below. |

To generate a transmission for a TB,
the HARQ process shall:

| | |
|---|---|
| 1> | if the MAC PDU was obtained from the Msg3 buffer; or |
| 1> | if the MAC PDU was obtained from the MSGA buffer; or |
| 1> | if there is no measurement gap at the time of the transmission and, in case of |
| | retransmission, the retransmission does not collide with a transmission for a MAC PDU |
| | obtained from the Msg3 buffer or the MSGA buffer: |

| | |
|---|---|
| 2> | if there are neither transmission of NR |
| | sidelink communication nor transmission of |
| | V2X sidelink communication at the time of the transmission; or |
| 2> | if the transmission of the MAC PDU is prioritized |
| | over sidelink transmission or can be |
| | simultaneously performed with sidelink transmission: |

| | |
|---|---|
| 3> | instruct the physical layer to generate a |
| | transmission according to the stored uplink |
| | grant. |

If a HARQ process receives downlink feedback information, the HARQ process shall:

| | |
|---|---|
| 1> | stop the eg-RetransmissionTimer, if running; |
| 1> | if acknowledgement is indicated: |

| | |
|---|---|
| 2> | stop the configuredGrantTimer, if running. |

If the configuredGrantTimer expires for a HARQ process, the HARQ process shall:

| | |
|---|---|
| 1> | stop the eg-RetransmissionTimer, if running. |

The transmission of the MAC PDU is prioritized
over sidelink transmission or can be performed
simultaneously with sidelink transmission if
one of the following conditions is met:

| | |
|---|---|
| - | if there are both a sidelink grant for |
| | transmission of NR sidelink communication and a |
| | configured grant for transmission of V2X |
| | sidelink communication on SL-SCH as |
| | described in clause 5.14.1.2.2 of TS 36.321 [22] at |
| | the time of the transmission, and neither |
| | the transmission of NR sidelink communication is |
| | prioritized as described in clause |
| | 5.22.1.3.1a nor the transmissions of |
| | V2X sidelink communication is prioritized as |
| | described in clause 5.14.1.2.2 |
| | of TS 36.321 [22]; or |
| - | if there are both a sidelink grant for transmission |
| | of NR sidelink communication and a |
| | configured grant for transmission of V2X |
| | sidelink communication on SL-SCH as |
| | described in clause 5.14.1.2.2 of TS 36.321 [22] |
| | at the time of the transmission, and the |
| | MAC PDU includes any MAC CE prioritized as |
| | described in clause 5.4.3.1.3 or the value |
| | of the highest priority of the logical |
| | channel(s) in the MAC PDU is lower than ul- |
| | PrioritizationThres if ul-PrioritizationThres |
| | is configured; or |
| - | if there are both a sidelink grant for |
| | transmission of NR sidelink communication and a |
| | configured grant for transmission of V2X |
| | sidelink communication on SL-SCH as |
| | described in clause 5.14.1.2.2 of TS 36.321 [22] at |
| | the time of the transmission, and the |
| | MAC entity is able to perform this UL transmission |
| | simultaneously with the transmission |
| | of NR sidelink communication and/or the transmissions |
| | of V2X sidelink communication; |
| | or |
| - | if there is only configured grant(s) for transmission |
| | of V2X sidelink communication on |
| | SL-SCH as described in clause 5.14.1.2.2 of TS 36.321 [22] |
| | at the time of the transmission, |
| | and either none of the transmissions of V2X |
| | sidelink communication is prioritized as |
| | described in clause 5.14.1.2.2 of TS 36.321 [22] |
| | or the MAC entity is able to perform this |
| | UL transmission simultaneously with the |
| | transmissions of V2X sidelink communication; |
| | or |
| - | if there is only a sidelink grant for transmission |
| | of NR sidelink communication at the time |
| | of the transmission, and if the MAC PDU includes |
| | any MAC CE prioritized as described. |
| | in clause 5.4.3.1.3, or the transmission of NR |
| | sidelink communication is not prioritized as |
| | described in clause 5.22.1.3.1a, or the value of |
| | the highest priority of the logical channel(s) |
| | in the MAC PDU is lower than ul-PrioritizationThres |
| | if ul-PrioritizationThres is |
| | configured, or there is a sidelink grant |
| | for transmission of NR sidelink communication at |
| | the time of the transmission and the MAC |
| | entity is able to perform this UL transmission |
| | simultaneously with the transmission |
| | of NR sidelink communication; or |
| - | if there are both a sidelink grant for |
| | transmission of NR sidelink communication and a |
| | configured grant for transmission of V2X |
| | sidelink communication on SL-SCH as |
| | described in clause 5.14.1.2.2 of TS 36.321 [22] at the |
| | time of the transmission, and either |
| | only the transmission of NR sidelink communication |
| | is prioritized as described in clause |
| | 5.22.1.3.1a or only the transmissions of V2X |
| | sidelink communication is prioritized as |
| | described in clause 5.14.1.2.2 of TS 36.321 [22] |
| | and the MAC entity is able to perform |
| | this UL transmission simultaneously with the |
| | prioritized transmission of NR sidelink |
| | communication or V2X sidelink communication: |

| NOTE 1: | Among the UL transmissions where |
|---|---|
| | the MAC entity is able to perform the |
| | transmission of NR sidelink communication |
| | prioritized simultaneously, if there are |
| | more than one UL transmission which the MAC |
| | entity is not able to perform |
| | simultaneously, it is up to UE implementation |
| | whether this UL transmission is |
| | performed. |
| NOTE 2: | Among the UL transmissions that |
| | the MAC entity is able to perform |
| | simultaneously with all transmissions of V2X |
| | sidelink communication prioritized, if |
| | there are more than one UL transmission |
| | which the MAC entity is not able to |
| | perform simultaneously, it is up to |
| | UE implementation whether this UL |
| | transmission is performed. |
| NOTE 3: | Among the UL transmissions where |

the MAC entity is able to perform the
transmission of NR sidelink communication
prioritized simultaneously with all
transmissions of V2X sidelink communication
prioritized, if there are more than
one UL transmission which the MAC entity is
not able to perform simultaneously,
it is up to UE implementation whether this
UL transmission is performed.

| | |
|---|---|
| NOTE 4 | If there is a configured grant for |

transmission of V2X sidelink communic

ation on SL-SCH as described in clause 5.14.1.2.2
of TS 36.321 [22] at the time of the tran
smission, and the MAC entity is not able to
perform this UL transmission simultaneously
with the transmission of V2X sidelink communication,
and prioritization-related information is
not available prior to the time of the transmission due
to processing time restriction, it is up to UE
implementation whether this UL
transmission is performed.

As an example, in case data arrives at a buffer of a terminal, the terminal may determine whether or not there is an uplink resource suitable for transmitting the data. If no suitable uplink resource for the data transmission is allocated to the terminal, the terminal may transmit an SR to a base station to request an uplink resource, which is the same as described above. In addition, in the terminal, a plurality of SRs may be mapped to each traffic type based on a SR configuration set from the base station. The terminal may trigger an SR by considering a traffic type and a priority order, transmit the SR to the base station, and be allocated an uplink resource. That is, based on a time of data occurrence to the terminal, data transmission may be performed based on signaling between the terminal and the base station, and thus a predetermined time of latency may occur.

Considering what is described above, a terminal may be equipped with an AI/ML model that learns uplink (UL) traffic prediction. As an example, the AI/ML model may perform UL traffic prediction based on various methods, and a method, by which the AI/ML model performs learning, may not be limited to a specific form. That is, an AI/ML model capable of learning UL traffic prediction may be provided in a terminal, and the terminal may only predict UL traffic, but a learning model or an AI/ML model for prediction may not be limited to a specific form.

Hereinafter, for convenience of explanation, the description will focus on a terminal equipped with an AI/ML model that has learned UL traffic prediction. Herein, as an example, the terminal equipped with an AI/ML model, which has learned UL traffic prediction, may predict beforehand whether or not a UL resource will occur. Herein, even before data occurs in a buffer, the terminal may trigger an SR based on prior prediction information in advance and transmit the SR to a base station before a data arrival time.

Herein, as UL traffic is predicted based on an AI/ML model, an SR transmission time may also be determined to be a specific time. Accordingly, the SR may be set to n SR resources at n candidate times. As an example, SR configuration information, which a base station sets for a terminal, may include information on n SR resources for n candidate times. Herein, an SR based on a specific time may be a predictive SR. However, the predictive SR is a term for convenience of explanation and may not be limited thereto. That is, a base station may set n SR resource for n candidate times based on an SR that is triggered before occurrence of data, and hereinafter, for convenience of explanation, the SR will be referred to as predictive SR. However, it may not be limited to any specific term.

As an example, not all terminals may be equipped with an AI/ML model that has learned UL traffic prediction. Whether or not there is an AI/ML model that has learned UL traffic prediction may be different according to each terminal, and AI/ML model-related information may also be different. As a concrete example, for a new communication system, a terminal may be equipped with an AI/ML model that has learned UL traffic prediction, but a legacy terminal may not be equipped with the above-described AI/ML model. Accordingly, whether or not a terminal is equipped with an AI/ML model that has learned UL traffic prediction is terminal capability, which may be shared with a base station through terminal capability information.

Considering what is described above, a base station may consult a terminal beforehand about whether or not the terminal has capability for an AI/ML model for UL traffic prediction. If the terminal is equipped with capability for an AI/ML model for UL traffic prediction, the base station may set one or more SR resources for a predictive SR for the terminal. Herein, when one or more predictive SR resources are allocated to the terminal, the terminal may perceive predictive information that occurs according to the AI/ML model for UL traffic prediction. Based on the predictive information obtained through the AI/ML model, the terminal may select at least any one or more of the one or more SR resources set in the terminal and request a UL resource before occurrence of data. That is, even before data arrives at a buffer, the terminal may transmit a predictive SR based on an AI/ML modeling result irrespective of whether or not data arrives and be allocated a UL resource.

As a concrete example, FIG. 6 is a view showing a method for operating a terminal according to an embodiment of the present disclosure. Referring to FIG. 6, a terminal may perform consultation with a base station about capability for an AI model (S610). That is, as described above, the terminal may deliver capability information based on whether or not it is equipped with an AI/ML model for UL traffic prediction to the base station. Considering the capability information of the terminal, the base station may perform SR configuration. As an example, if the terminal is equipped with an AI/ML model for UL traffic prediction, the base station may deliver a predictive SR configuration including setting information of a plurality of predictive SR resources to the terminal (S620). Based on predictive SR configuration information received from the base station, the terminal may trigger at least one or more predictive SRs among the plurality of predictive SR resources set in the predictive SR configuration information by reflecting a result of the AI/ML model (S630). Next, the terminal may select at least one or more predictive SRs and transmit the SRs to the base station irrespective of whether or not data occurs in a buffer (S640).

Herein, as an example, the terminal may collect data related to the generation and transmission for UL traffic. In addition, the terminal may be equipped with an AI/ML model that performs learning for traffic generation according to a feature of the terminal. Based on the AI/ML model provided in the terminal, the terminal may inform the base station of its capability during a capability negotiation process.

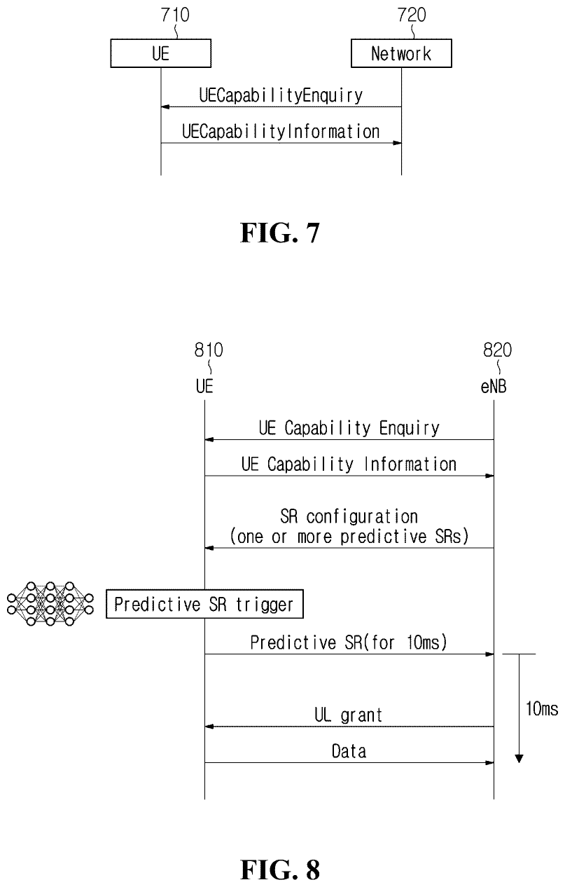

As an example, FIG. 7 is a view showing a method by which a terminal and a base station perform capability negotiation according to an embodiment of the present disclosure. Referring to FIG. 7, a terminal 710 may receive a terminal (or UE) capability enquiry message (UECapabilityEnquiry) from a base station 720 and deliver terminal capability information based on the message to the base station 720. Herein, the terminal may deliver the above-described information regarding whether or not it is equipped with an AI/ML model performing learning for UL traffic prediction to the base station. When the terminal delivers the information regarding whether or not it is equipped with the AI/ML model to the base station, the terminal and the base station may perceive whether there is the AI/ML model based on a capability negotiation procedure and perform capability negotiation.

As another example, the terminal and the base station may generate a new procedure for capability negotiation considering an AI/ML operation. That is, the terminal and the base station may use a new capability negotiation procedure for an AI/ML operation. As a concrete example, the terminal and the base station may use an existing capability negotiation procedure for other pieces of capability information. On the other hand, for AI/ML model-related capability, the terminal and the base station may perform a capability negotiation procedure as a new capability negotiation procedure for an AI/ML model but is not limited to a specific form.

As an example, in case the terminal and the base station use a RRC message in a new capability negotiation procedure related to an AI/ML model like in an existing terminal capability negotiation procedure, a new information element (IE) may be defined to transmit AI/ML-related capability information of the terminal. Herein, the IE may include information on an AI/ML model related to UL traffic prediction. As an example, consultable information between the terminal and the base station may include at least any one or more pieces of information in Table 6 below.

Specifically, information consulted between the terminal and the base station may include not only information regarding whether the terminal is equipped with an AI/ML model but also information on a learning method of the AI/ML model. As an example, the AI/ML model may learn based on an offline method or an online method but is not limited to a specific form. In addition, as an example, for learning of the AI/ML model, input information, learning information, and inference data information may be included as negotiated information. That is, the terminal may deliver information related to an operation of its AI/ML model to perform data traffic prediction as AI/ML model-related information to the base station through a capability negotiation procedure.

As another example, information consulted between the terminal and the base station may be traffic type information about output data based on the AI/ML model. As an example, a traffic type may be set based on a logical channel (LCH) unit, a logical channel group (LCG) unit, or a data radio bearer unit, and the negotiated information may include information regarding which traffic type is reflected by the output data based on the AI/ML model.

As another example, consulted information may include information on a time unit for time information for occurrence of traffic for output data based on the AI/ML model. As an example, the time unit may be a unit for perceiving prediction. As a concrete example, the time unit may be 0.5 ms, but this is merely one example and the present disclosure may not be limited thereto.

As another example, as output data based on the AI/ML model, information on a prediction start time and a prediction end time for traffic occurrence may be included in consulted information. That is, for capability information, information on an interval, during which prediction is possible through the AI/ML model, may be delivered to the base station. As a concrete example, based on AI/ML model output data, information on prediction of traffic likely to occur between 0.5 ms and 10 ms may be included in negotiated information, but this is merely one example, and the present disclosure is not limited thereto.

TABLE 6
- For AI/ML model information, information on a training method (offline or online)
and information on input/training/inference data
- For output, traffic type information (e.g., LCH ID or LCG ID or data radio bearer id,
etc.)
- For output, time-unit information on traffic occurrence time (e.g., 0.5ms when an
occurrence time is predicted in units of 0 to 0.5ms)
- For output, information regarding an interval for predicting occurrence of traffic (e.g.,
prediction of traffic likely to occur between 0.5ms and 10ms)

FIG. 7 is a view showing a method for performing a capability negotiation procedure between a terminal and a base station according to an embodiment of the present disclosure. As an example, referring to FIG. 7, a terminal 710 and a base station 720 may perform a capability negotiation procedure. Herein, the above-described AI model-related capability information may be delivered in the capability negotiation procedure. As a more concrete example, the terminal 710 and the base station 720 may exchange capability information for a traffic prediction-related AI model of the terminal 710, and this is the same as described above. The base station 720 may check the capability information for the traffic prediction-related AI model from the terminal 710 and set a predictive SR for the terminal 710.

Herein, traffic prediction for the predictive SR may be an AI/ML model that notifies a time when UL traffic of a terminal occurs. As an example, input data for the AL/ML model may be information reflecting environment information of a terminal and status information of the terminal. Based on an AI/ML model, the terminal 710 may use environment information and terminal status information as input data to derive, as output data, an expected time when UL traffic arrives at a buffer of the terminal. As an example, the environment information and the terminal status information may be a the location, moving speed, time and application use frequency of the terminal and other information but may not be limited to a specific form. Herein, the output data may be information on an expected time of data occurrence.

As an example, a time interval unit for expected time information derived as output data may be set in various ways. A time interval unit for time information may be set based on at least any one of symbol, slot, ms, subframe, and frame unit, but this is merely one example, and the present disclosure may not be limited to a specific form. Herein, time interval unit information for time information may be determined while the terminal 710 and the base station 720 perform a capability negotiation procedure. As another example, time interval unit information may be determined to be a preset value. As an example, a time interval unit may be defined as a preset value of a standard but may not be limited thereto.

Herein, output data derived through an AI/ML model may be as shown in Table 7 below. As a concrete example, a time interval unit of an expected time based on an AI/ML model may be determined through a capability negotiation procedure between the terminal 710 and the base station 720. In Table 7, a time interval unit is determined to be 0.5 ms or a symbol unit but may not be limited thereto. Referring to FIG. 7, an expected time of arrival of UL data at a buffer of the terminal 710 may be derived according to each traffic type (or logic channel), and thus the terminal 710 may transmit a predictive SR to the base station 720 in advance.

TABLE 7

- Traffic type(Logical channel) A, 1ms or 14 symbols
- Traffic type(Logical channel) B, 0.5ms or 7 symbols
- Traffic type(Logical channel) C, 2ms or 28 symbols

As an example, in the terminal 710, a traffic prediction-related AI/ML model may operate at a specific time interval based on a preset time interval. Herein, when output data derived based on the AI/ML model is determined to be a value within a time determined by a negotiation procedure, the terminal 710 may trigger a predictive SR.

That is, unlike when an SR is triggered based on a BSR that is triggered in a previous wireless communication system, a predictive SR is triggered in advance, and then a BSR for a traffic type may be triggered when actual data is received. As an example, after the BSR is triggered, the terminal 710 may check whether or not there is a predictive SR that is triggered and transmitted before. Herein, if there is a predictive SR corresponding to the traffic type of the triggered BSR, the terminal 710 may not trigger any new SR but immediately use an UL resource for BSR transmission, thereby reducing latency.

As another example, it is possible to consider a case in which the AI/ML model of the terminal 710 is capable of predicting a buffer size. That is, the AI/ML model may derive not only a predicted time of UL occurrence but also a buffer size as output data. As an example, in a previous wireless communication system, the terminal 710 could report a buffer size based on a buffer status report (BSR) to the base station 720. Here, when the terminal 710 derives a buffer size as output data based on the AI/ML model, the terminal 710 may trigger and deliver a predictive BSR to the base station 720. Herein, a predictive BSR medium access control (MAC) control element (CE) field for the predictive BSR may be as shown in Table 8 below but may not be limited thereto. That is, the predictive BSR MAC CE may include at least any one of an LCG ID, a predicted buffer size, and a predicted traffic arrival time value, and corresponding information may be reported to the base station 720.

TABLE 8

- LCG ID (existing information); and
- Predictive Buffer size; and/or
- Predicted traffic arrival time value

In addition, as an example, the operation of the terminal 710 may be different according to whether or not there is a UL resource capable of transmitting a triggered predicted BSR. As an example, when there is a UL resource in the terminal 710, the terminal 710 may transmit the above-described BSR MAC CE through the UL resource. On the other hand, when there is no UL resource for transmitting the triggered predictive BSR, a predicted BSR of the terminal 710 may trigger an SR. As an example, an SR triggered based on a predictive BSR may be an existing SR or the above-described predicted SR but may not be limited to a specific form.

Herein, if the SR is an existing SR, the terminal may trigger an SR mapped to a logical channel that triggers the predictive BSR. The terminal may transmit the predictive BSR by using a resource allocated by the SR that triggered by the predictive BSR. Herein, the transmitted predicted BSR may include a predicted traffic arrival value among the values of Table 8 but may not be limited thereto.

As another example, the predictive BSR may be transmitted in advance before data arrives at a buffer. Accordingly, an SR for transmitting the predictive BSR may be used. Herein, the SR for transmitting the predictive BSR may be a resource request such that the base station 720 may allocate a UL resource to transmit a predictive BSR MAC CE. The terminal 710 may transmit the predictive BSR by using the resource allocated by the SR for transmitting the predictive BSR. In addition, the terminal 710 may expect to be allocated the UL resource from the base station 720 based on the predicted traffic arrival value in the predictive BSR, but may not be limited thereto.

As another example, the predictive BSR may trigger the above-described predictive SR. Herein, as the predictive SR is triggered, the predictive BSR may not include the predicted traffic arrival value of Table 8. At this time, the predicted traffic arrival value may be delivered to the base station 720 through the predictive SR.

Based on what is described above, the base station 720 may set at least one or more predictive SRs for the terminal 710, and resource information for the predictive SRs needs to be determined.

Specifically, a base station may set n predictive SRs for a terminal. As an example, the terminal may trigger an SR based on a logical channel and transmit the SR to the base station but not be limited thereto. The base station may set an SR PUCCH resource corresponding to information related to an SR configuration for the logical channel for the terminal. When n predictive SRs are set for the terminal, information on n times may be set as an additional separate SR PUCCH.

As an example, n predictive SR PUCCHs may be set for an SR including a highest logical channel. As a more concrete example, it is possible to consider a case in which a terminal performs data transmission through a logical channel 0, a logical channel 1 and a logical channel 2. Herein, if two predictive SR PUCCHs are set, three SR PUCCHs may be set for the logical channel 0, the logical channel 1 and the logical channel 2, as shown in Table 9 below. That is, not only an SR PUCCH corresponding to an SR triggered based on data occurrence but also an SR PUCCH corresponding to a predictive SR triggered based on data prediction may be set in the terminal.

Specifically, like an SR PUCCH in an existing wireless communication system, an SR PUCCH may be configured for an SR according to data occurrence for the logical channel 0, the logical channel 1 and the logical channel 2. In addition, additional two predictive SR PUCCH configurations may be set for a terminal. Herein, each predictive SR PUCCH may be set based on a different configuration. As an example, in Table 9, the SR PUCCH 1 may be set as an SR PUCCH configuration for the logical channel 0, the logical channel 1 and the logical channel 2 based on output data that predicts occurrence of data in 0.5 ms based on an AI/ML model. On the other hand, the SR PUCCH 2 may be set as an SR PUCCH configuration for the logical channel 0, the logical channel 1 and the logical channel 2 based on output data that predicts occurrence of data in Ims based on an AI/ML model. However, this is merely one example, and the present disclosure is not limited to the above-described embodiment. A terminal may selectively use a plurality of SR PUCCHs configured in the terminal according to a case in which data arrives at a buffer and a case in which data arrival is predicted based on an AI/ML model.

As an example, in a wireless communication system, an SR PUCCH may set for one or more logical channels. Herein, as described above, the SR PUCCH for one or more logical channels may be an SR PUCCH for an SR based on data occurrence and an SR based on prediction of data occurrence.

TABLE 9
- SR PUCCH 0 - SR based on data occurrence for LCH 0/1/2,
- SR PUCCH 1 - SR based on an ML model that predicts data occurrence for LCH
0/1/2 in 0.5ms,
- SR PUCCH 2 - SR based on an ML model that predicts data occurrence for LCH
0/1/2 in 1ms.

FIG. 8 is a view showing a method for triggering a predictive SR according to an embodiment of the present disclosure.

As an example, referring to FIG. 8, a terminal 810 and a base station 820 may perform negotiation about a terminal capability negotiation procedure. Herein, information regarding whether the terminal 810 is equipped with an AI/ML model and information related to the AI/ML model may be exchanged between the terminal 810 and the base station 820, and this is the same as described above. As an example, it is possible to consider a case in which the base station 820 sets n predictive SRs for the terminal 810. Herein, in the terminal 810, an SR PUCCH resource, which is independent of an existing SR configuration, may be set for a predictive SR, and this is the same as described above. Specifically, it is possible to consider a case in which n pieces of time information are set for n predictive SRs. As a concrete example, if n is 4, the time information may be 0.5 ms (7 symbols), 1 ms (14 symbols), 1.5 ms (21 symbols) and 2 ms (28 symbols), and based on the time information, 4 pieces of SR PUCCH information may be additionally set. However, this is merely one example, and the present disclosure may not be limited thereto.

In case the terminal 810 has at least one or more predictive SRs set from the base station 820, the terminal 810 may transmit an SR according to prediction of data occurrence to the base station 820 in advance even when data does not arrive at a buffer.

Based on the received SR, the base station 820 may obtain information on a UL resource allocation time desired by the terminal 810 and allocate a UL resource (UL grant) at the time or immediately after the time. In case data predicted based on the received UL resource successfully occurs to the buffer, the terminal 810 may perform data transmission through the UL resource allocated through the SR, and this may be the same as described in FIG. 8.

As another example, reliability information may be derived as accuracy information for output data that is derived based on an AI/ML model that is a traffic prediction model, and the reliability information may be transmitted to the base station 820 together. Herein, in case the base station 820 receives a predictive SR from two or more terminals simultaneously, if the two or more terminals request a same time of resource, the base station 820 may not have sufficient resources to allocate to the two or more terminals. As an example, if the base station 820 has sufficient resources to allocate to the two or more terminals, the base station 820 may allocate a UL resource to each of the terminals. On the other hand, the base station 820 does not have sufficient resources to allocate to the two or more terminals, the base station 820 may determine a priority order among the terminals and allocate a UL resource to a terminal with a high priority.

Herein, as a predictive SR is triggered for data that is predicted before actual occurrence of data, its accuracy for the actual occurrence of data may not be 100%. That is, at a corresponding time of the predictive SR, actual data may not occur to a terminal. Considering what is described above, the terminal 810 may transmit reliability information of output data of an AI/ML model as well as the predictive SR to the base station 820. As another example, reliability information may be included in the predictive SR but not be limited to a specific form.

As a concrete example, referring to Table 10 below, a predictive SR may deliver reliability information as well as information on a specific logical channel and information on a predicted data occurrence to the base station 820. As an example, Table 10 may be a method of operating the terminal 810 based on a plurality of predictive SRs set in the terminal 810 but not be limited thereto. Herein, the base station 820 may receive a predictive SR including reliability information from the terminal 810 and determine a priority order for a plurality of terminals by reflecting the received reliability information.

TABLE 10
- Predictive SR1: LCH ID 1/2/3, traffic arrival time 5ms, output reliability 90%
- Predictive SR2: LCH ID 1/2/3, traffic arrival time 5ms, output reliability 95%
- Predictive SR3: LCH ID 1/2/3, traffic arrival time 5ms, output reliability 99%

As another example, it is possible to consider a case in which a prediction based on output data derived based on an AI/ML model of a terminal is not right. That is, the terminal may predict occurrence of specific data and an occurrence time thereof based on the output data of the AI/ML model and transmit a predictive SR to a base station. Then, the terminal is allocated a UL resource from the base station, but actual data may not occur. Herein, as an example, the terminal may inform the base station that the UL resource is not used. As a concrete example, in case the terminal is already allocated the UL resource based on the predictive SR, the terminal may set a BSR value to 0 (BSR=0) and transmit the BSR value to the base station.

As another example, an MAC CE may be set based on predictive SR cancellation. That is, through transmission of the MAC CE meaning predictive SR cancellation, the terminal may inform the base station that the allocated UL resource based on the predictive SR is not used. As another example, the terminal may transmit a physical uplink shared channel (PUSCH) that includes null data in the allocated UL resource. Thus, the terminal may indicate to the base station that a resource for a UL grant is transmission of meaningless data.

As an example, based on the indicated information, the base station may perceive that an HARQ operation and error recovery procedure based on the UL resource is unnecessary. The base station may deliver the above-described information to an upper layer and prevent a corresponding procedure from being performed, but may not be limited thereto.

In addition, as an example, the terminal may perceive an error of data occurrence prediction in advance after transmitting the predictive SR. That is, after transmitting the predictive SR, the terminal may perceive the error of data occurrence prediction before the UL resource is allocated. Herein, the terminal may indicate to the base station that the transmission of the predictive SR is erroneous transmission (or is to be canceled). As an example, an SR PUCCH may be additionally set based on SR cancellation information. That is, by transmitting the SR PUCCH meaning the SR cancellation information to the base station, the terminal may indicate to the base station that the corresponding predictive SR is cancelled. Thus, the base station may not allocate an unnecessary UL resource to the terminal and prevent resource waste.

As another example, the predictive SR needs to be set in a logical channel with a higher priority. As an example, it may be set for a delay sensitive traffic type like URLLC traffic, and thus delay may be reduced.

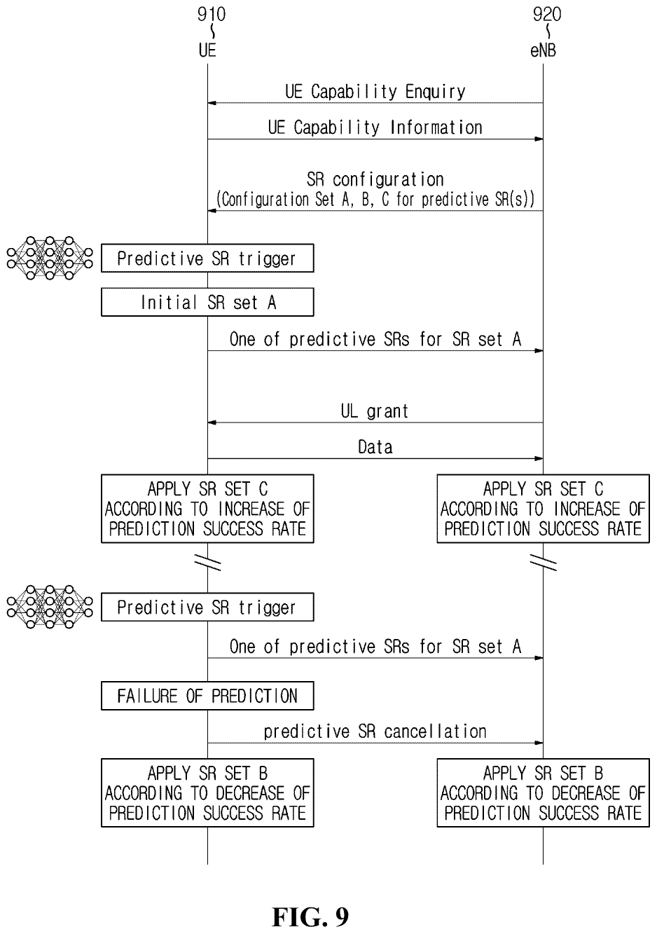

FIG. 9 is a view showing a method by which a plurality of SR configuration sets are set in a terminal according to an embodiment of the present disclosure.

Referring to FIG. 9, a terminal 910 and a base station 920 may perform a capability negotiation procedure, information related to an AI/ML model may be exchanged between the terminal 910 and the base station 920 based on the procedure, and this is the same as described above.

Next, the base station 920 may set a plurality of SR setting sets for predictive SRs for the terminal 910 through a RRC message based on an SR configuration. As an example, the plurality of SR setting sets for the predictive SRs may be configured based on n predicted time values. Herein, if the base station 920 resets an SR setting set for another predicted time value, the base station 920 may reset an SR configuration of the terminal 910 by transmitting a new RRC message.

In addition, as an example, in the SR configuration, a preset range value for a data prediction success rate may be allocated to each SR setting set in advance. As a concrete example, for the plurality of SR setting sets, the base station 920 may set an SR setting set A, an SR setting set B and an SR setting set C for the terminal 910. Herein, a corresponding prediction success rate for each of the SR setting set may be as follows: 70% and below for the SR setting set A, 70% to 90% for the SR setting set B, and 90% and above for the SR setting set C. However, this is merely one example, and the present disclosure may not be limited thereto.

Herein, the terminal 910 and the base station 920 may dynamically modify an SR setting set based on a calculated prediction success rate. As an example, a prediction success rate may be calculated by the terminal 910. As another example, a prediction success rate may be information that is derived by the base station 920 and is given to the terminal 910 as feedback, which is not limited to a specific embodiment.

Herein, the terminal 910 and the base station 920 may operate based on a prediction success rate. Referring to Table 11, based on a prediction success rate, the terminal 910 may determine whether or not to apply the SR setting set A, the SR setting set B and the SR setting set C. Based on a prediction success rate, the terminal 910 may set not only a different number of SRs but also a different interval. As an example, if the prediction success rate is low, the terminal 910 may use the SR setting set A as a most basic SR setting set. Herein, the SR setting set A may have a short predictable time, which may produce a relatively high accuracy of prediction accordingly. That is, when the prediction success rate is not high, the terminal 910 may use a minimum SR setting set to prevent an unnecessary UL resource from being used because of prediction failure. On the other hand, if the prediction success rate is high, the terminal 910 may use an SR setting set with a value of a long prediction time, and thus a predictive SR may be efficiently applied.

TABLE 11
- If a prediction success rate is equal to or below 70%, set A {SR1 - 1ms, SR2 -
2ms} - default SET (SET that may be used initially)
- If a prediction success rate is between 70% and 90%, set B {SR1 - 1ms, SR2 -
2ms, SR3 - 3ms}
- If a prediction success rate is equal to or above 90%, set C {SR1 - 1ms, SR2 -
2ms, SR3 - 3ms, SR4 - 4ms ...}

Specifically, referring to FIG. 9, the terminal 910 may perform a capability negotiation procedure related to an AI/ML model with the base station 920. The base station 920 may set one or more SR configuration sets including at least one or more predictive SRs for the terminal 910 with capability of traffic prediction. As an example, as described above, the base station 920 may set, predictive SR sets, the SR setting set A, the SR setting set B and the SR setting set C for the terminal 910. Herein, each of the SR setting sets may correspond to a prediction success rate value according to Table 11.

The terminal 910 may predict a data occurrence time based on output data of a traffic prediction AI/ML model of the terminal. Herein, the terminal 910 may trigger a predictive SR based on at least one of predictive SRs that are mapped for a default SR setting set (default SET A). Next, the terminal 910 may transmit the triggered predictive SR to the base station 920. The base station 920 may allocate a UL resource at a time corresponding to the received predictive SR or immediately after the time and transmit a UL grant including information on the resource to the terminal 910. In case data predicted based on the UL grant occurs, the terminal 910 may transmit the data by using the allocated UL resource. Herein, when the terminal 910 successfully transmits the data and the base station 920 successfully receives the data, a prediction success rate may be set to 100%. Herein, the terminal 910 may apply the SR setting set C based on Table 11 described above. That is, the terminal 910 may initially trigger a predictive SR based on a default SR setting set. Next, the terminal 910 may determine an SR setting set that is applied by reflecting a prediction success rate. Thus, the terminal 910 may use a predictive SR by reflecting a prediction success rate.

As another example, the terminal 910 may predict occurrence of data in the terminal based on a traffic prediction AI/ML model of the terminal. Herein, the terminal 910 may trigger a predictive SR based on at least any one of predictive SRs that are mapped to the SR setting set C as a default SR configuration set. Next, the terminal 910 may transmit the triggered predictive SR to the base station 920. The base station 920 may allocate a UL resource at a time corresponding to the received predictive SR or immediately after the time and transmit information on the resource to the terminal 910 through a UL grant. Herein, in case data of the terminal 910 does not occur at the predicted time, the terminal 910 may perceive that the prediction is wrong, and instruct the base station to cancel the predictive SR. That is, the terminal 910 may indicate SR cancellation information to the base station 920 based on at least one of an SR PUCCH based on the SR cancellation information, an MAC CE based on SR cancellation, a BSR value set to 0, and a PUSCH including null data.

Herein, the terminal 910 and the base station 920 may perceive that prediction is wrong. Accordingly, the terminal 910 and the base station 920 may lower the prediction success rate (e.g., set 80% according to 20% decrease) and apply the SR setting set B for a predictive SR based on Table 11.

As another example, the terminal 910 and the base station 920 may share a policy by dynamically changing an SR setting in an SR configuration based on the success and failure of prediction. Herein, the policy may consider the number of SRs based on predictive transmission success/estimation in a time window. As an example, the number of SRs based on predictive transmission success/estimation may be counted in the time window. In addition, as an example, the policy may set a maximum number of failures for predictive transmission in the time window. That is, in a specific time window, whether or not prediction is successful may be counted, and an operation may be performed when a maximum number of failures is reached. Herein, the operation may be an operation of setting an SR setting set to a minimum value. As another example, a maximum value and a minimum value may be set for the number of SRs. Herein, the above-described information may be included in SR configuration information and be signaled to the terminal 910. That is, the terminal may perform an operation for a predictive SR according to a policy based on SR configuration information.

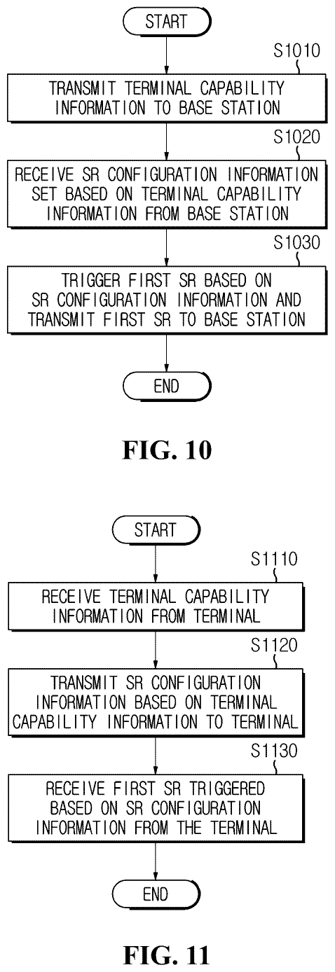

FIG. 10 is a flowchart showing a method by which a terminal performs resource request according to an embodiment of the present disclosure.

Referring to FIG. 10, the terminal may transmit terminal capability information to a base station (S1010). Herein, as described above, the terminal may perform a capability negotiation procedure with the base station. Herein, the terminal may be a terminal equipped with an AI/ML model for UL traffic prediction. In addition, the terminal may predict an occurrence time of first data in a buffer of the terminal through the AI/ML model for UL traffic prediction. The terminal capability information may include at least one of information regarding whether or not a terminal is equipped with an AI/ML model for uplink traffic prediction, information on a method of performing learning based on the AI/ML model, type information of output data for the AI/ML model, time unit information for a traffic occurrence time for the output data, and predictable time information based on the AI/ML model, and this is the same as described above. Next, the terminal may receive SR configuration information set based on the terminal capability information from the base station (S1020). Next, the terminal may trigger a first SR based on the SR configuration information and transmit the first SR to the base station (S1030). Herein, the first SR may be an SR that is triggered before the first data occurs to the buffer of the terminal, and this is the same as described above.

In addition, buffer size information based on the first data may further be predicted through the AI/ML model for UL traffic prediction of the terminal.

Herein, when the buffer size information based on the first data is predicted, the terminal may trigger and transmit a first BSR including at least one of identification information for the first data, occurrence time information of the first data, and the buffer size information based on the first data to the base station.

Herein, when a UL resource for the triggered first BSR is not present in the terminal, an SR may be triggered and transmitted to the base station, and when the triggered SR is a first SR, the first BSR may include the identification information for the first data and the buffer size information based on the first data, and occurrence time information of the first data may be indicated to the base station through the first SR.

In addition, based on the SR configuration information, at least one or more first SR PUCCH resources and at least one or more second SR PUCCH resources may be set in the terminal. Herein, the at least one or more first SR PUCCHs may be PUCCH resources for transmission of an SR that is triggered based on occurrence time prediction of the first data before data occurs to the buffer of the terminal, and the at least one or more second SR PUCCHs may be PUCCH resources for transmission of an SR that is triggered based on data that occurs to the buffer of the terminal. As another example, based on the SR configuration information, a third SR PUCCH resource may further be set in the terminal. Herein, the third SR PUCCH resource may be a PUCCH resource that cancels the first SR based on prediction failure information regarding non-occurrence of the first data at an occurrence time based on occurrence time prediction, and this is the same as described above.

In addition, as an example, the first SR may include the identification information for the first data and occurrence time prediction information of the first data. The first SR may further include prediction success rate information indicating that the first data occurs at an occurrence time based on the occurrence time prediction information of the first data. Herein, the SR configuration information may include information on a plurality of SR setting sets based on the prediction success rate information. The terminal may trigger the first SR based on a first SR setting set among the plurality of SR setting sets. In addition, the terminal may dynamically change an SR setting set in the terminal based on the prediction success rate information. In addition, as an example, when the terminal receives a UL grant indicating a UL resource based on the first SR from the base station and the first data does not occur at a predicted occurrence time, the terminal may indicate cancellation of the first SR to the base station.

Herein, the cancellation of the first SR may be indicated through at least one of an MAC CE indicating the cancellation of the first SR, a BSR set to 0, and a PUSCH including null data, and this is the same as described above.

In addition, when the terminal detects, based on the SR configuration information, that data occurs to the buffer of the terminal, the terminal may trigger and transmit a second SR to the base station. That is, the second SR may be an existing SR.

FIG. 11 is a flowchart showing a method by which a base station allocates an uplink resource based on a resource request according to an embodiment of the present disclosure.

Referring to FIG. 11, a base station may receive terminal capability information from a terminal (S1110). Herein, as described above, the terminal and the base station may perform a capability negotiation procedure. Herein, the terminal may be a terminal equipped with an AI/ML model for UL traffic prediction. In addition, the terminal may predict an occurrence time of first data in a buffer of the terminal through the AI/ML model for UL traffic prediction. The terminal capability information may include at least one of information regarding whether or not a terminal is equipped with an AI/ML model for uplink traffic prediction, information on a method of performing learning based on the AI/ML model, type information of output data for the AI/ML model, time unit information for a traffic occurrence time for the output data, and predictable time information based on the AI/ML model, and this is the same as described above. Next, the base station may set an SR configuration based on the terminal capability information and transmit information on the set SR configuration to the terminal (S1120). Next, the base station may receive a first SR, which is triggered based on the SR configuration information, from the terminal (S1130). Herein, the first SR may be an SR that is triggered before the first data occurs to the buffer of the terminal, and this is the same as described above.

In addition, buffer size information based on the first data may further be predicted through the AI/ML model for UL traffic prediction of the terminal.

Herein, when the buffer size information based on the first data is predicted, the terminal may trigger and transmit a first BSR including at least one of identification information for the first data, occurrence time information of the first data, and the buffer size information based on the first data to the base station.

Herein, when a UL resource for the triggered first BSR is not present in the terminal, an SR may be triggered and transmitted to the base station, and when the triggered SR is a first SR, the first BSR may include the identification information for the first data and the buffer size information based on the first data, and occurrence time information of the first data may be indicated to the base station through the first SR.

In addition, based on the AI/ML model for UL traffic prediction of the terminal, reliability information of the first SR may further be derived, and this may be as shown in Table 10 described above. Herein, the reliability information of the first SR may be transmitted to the base station with the first SR.

In addition, based on the SR configuration information, at least one or more first SR PUCCH resources and at least one or more second SR PUCCH resources may be set in the terminal. Herein, the at least one or more first SR PUCCHs may be PUCCH resources for transmission of an SR that is triggered based on occurrence time prediction of the first data before data occurs to the buffer of the terminal, and the at least one or more second SR PUCCHs may be PUCCH resources for transmission of an SR that is triggered based on data that occurs to the buffer of the terminal. As another example, based on the SR configuration information, a third SR PUCCH resource may further be set in the terminal. Herein, the third SR PUCCH resource may be a PUCCH resource that cancels the first SR based on prediction failure information regarding non-occurrence of the first data at an occurrence time based on occurrence time prediction, and this is the same as described above.

In addition, as an example, the first SR may include the identification information for the first data and occurrence time prediction information of the first data. The first SR may further include prediction success rate information indicating that the first data occurs at an occurrence time based on the occurrence time prediction information of the first data. Herein, the SR configuration information may include information on a plurality of SR setting sets based on the prediction success rate information. The terminal may trigger the first SR based on a first SR setting set among the plurality of SR setting sets. In addition, the terminal may dynamically change an SR setting set in the terminal based on the prediction success rate information. In addition, as an example, when the terminal receives a UL grant indicating a UL resource based on the first SR from the base station and the first data does not occur at a predicted occurrence time, the terminal may indicate cancellation of the first SR to the base station.

Herein, the cancellation of the first SR may be indicated through at least one of an MAC CE indicating the cancellation of the first SR, a BSR set to 0, and a PUSCH including null data, and this is the same as described above.

In addition, when the terminal detects, based on the SR configuration information, that data occurs to the buffer of the terminal, the terminal may trigger and transmit a second SR to the base station. That is, the second SR may be an existing SR.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving, from a base station, terminal capability enquiry message;
transmitting terminal capability information to the base station;
receiving, from the base station, scheduling request (SR) configuration information based on the terminal capability information;
triggering a first SR based on the SR configuration information; and
transmitting the first SR to the base station,
wherein the first SR is an SR that is triggered and transmitted to the base station before first data occurs in a buffer of the terminal.

2. The method of claim 1, wherein the terminal is equipped with an artificial intelligence (AI)/machine learning (ML) model for uplink traffic prediction, and
wherein an occurrence time of the first data in the buffer of the terminal is predicted through the AI/ML model for the uplink traffic prediction.

3. The method of claim 2, wherein the terminal capability information includes at least one of information related to whether the terminal is equipped with the AI/ML model for the uplink traffic prediction, information related to a method of performing learning based on the AI/ML model, type information of output data for the AI/ML model, time unit information for a traffic occurrence time for the output data, and predictable time information based on the AI/ML model.

4. The method of claim 2, wherein buffer size information based on the first data is further predicted through the AI/ML model for the uplink traffic prediction of the terminal.

5. The method of claim 4, wherein based on the buffer size information based on the first data being predicted, the terminal triggers and transmits a first buffer status report (BSR) including at least one of identification information for the first data, occurrence time information of the first data, and the buffer size information based on the first data to the base station.

6. The method of claim 5, wherein based on an uplink resource for the triggered first BSR being not present in the terminal, an SR is triggered and transmitted to the base station,
wherein based on the triggered SR being the first SR, the first BSR includes the identification information for the first data and the buffer size information based on the first data, and
wherein the occurrence time information of the first data is indicated to the base station through the first SR.

7. The method of claim 2, wherein reliability information of the first SR is further derived based on the AI/ML model for the uplink traffic prediction of the terminal, and
wherein the reliability information of the first SR is transmitted to the base station with the first SR.

8. The method of claim 1, wherein based on the SR configuration information, at least one first SR physical uplink control channel (PUCCH) resource and at least one second SR PUCCH resource are set in the terminal,
wherein the at least one SR PUCCH resource is a PUCCH resource for SR transmission that is triggered based on the occurrence time prediction of the first data before data occurs in the buffer of the terminal, and
wherein the at least one second SR PUCCH resource is a PUCCH resource for SR transmission that is triggered based on data that occurs in the buffer of the terminal.

9. The method of claim 8, wherein a third SR PUCCH resource is further set in the terminal based on the SR configuration information, and
wherein the third SR PUCCH resource cancels the first SR based on prediction failure information indicating that the first data does not occur at an occurrence time based on the occurrence time prediction.

10. The method of claim 1, wherein the first SR includes the identification information for the first data and occurrence time prediction information of the first data.

11. The method of claim 10, wherein the first SR further includes prediction success rate information indicating that the first data occurs at the occurrence time based on the occurrence time prediction information of the first data.

12. The method of claim 11, wherein the SR configuration information includes information related to a plurality of SR setting sets based on the prediction success rate information, and
wherein the terminal triggers the first SR based on a first SR setting set that is set among the plurality of SR setting sets, and the SR setting set, which is set in the terminal, is dynamically changed based on the prediction success rate information.

13. The method of claim 1, further comprising:
receiving, from the base station, an uplink grant indicating an uplink resource based on the first SR, and
wherein based on the first data not occurring at a predicted occurrence time, the terminal indicates cancellation of the first SR to the base station.

14. The method of claim 13, further comprising:
indicating the cancellation of the first SR through at least one of a medium access control (MAC) control element (CE) indicating the cancellation of the first SR, a BSR set to 0, and a physical uplink shared channel (PUSCH) including null data.

15. The method of claim 1, wherein in case that the terminal detects occurrence of data in the buffer of the terminal based on the SR configuration information, the terminal triggers and transmits a second SR to the base station.

16. (canceled)

17. A terminal comprising:
a transceiver; and
a processor coupled with the transceiver,
wherein the processor is configured to:
receive, from a base station, terminal capability enquiry message,
transmit terminal capability information to the base station,
receive, from the base station, scheduling request (SR) configuration information based on the terminal capability information,
trigger a first SR based on the SR configuration information, and
transmit the first SR to the base station,
wherein the first SR is an SR that is triggered and transmitted to the base station before first data occurs in a buffer of the terminal.

18-20. (canceled)

21. A base station comprising:
a transceiver; and
a processor coupled with the transceiver,
wherein the processor is configured to:
transmit, to a terminal, terminal capability enquiry message,
receive, from the terminal, terminal capability information,
transmit, to the terminal, scheduling request (SR) configuration information based on the terminal capability information, and
receive, from the terminal, a first SR triggered based on the SR configuration information, and
wherein the first SR is an SR that is triggered and transmitted to the base station before first data occurs in a buffer of the terminal.
